(19) United States
(12) Patent Application Publication
(10) Pub. No.: US 2021/0370971 A1
(43) Pub. Date: Dec. 2, 2021

(54) AUTOMATED ROUTING GRAPH MODIFICATION MANAGEMENT

(71) Applicant: Uber Technologies, Inc., San Francisco, CA (US)

(72) Inventors: Alvin AuYoung, San Jose, CA (US); Chaoqun Tao, Emeryville, CA (US); Anny Xinda Yang, San Francisco, CA (US); Christopher James Lyons, Oakland, CA (US); Bryan John Nagy, Allison Park, PA (US); Quinn Zikun Shen, San Francisco, CA (US); Michael Beeheng Goff, San Mateo, CA (US); Alexander Rashid Ansari, San Francisco, CA (US); Qing Li, Union City, CA (US)

(21) Appl. No.: 17/303,440

(22) Filed: May 28, 2021

Related U.S. Application Data
(60) Provisional application No. 63/031,178, filed on May 28, 2020.

(51) Int. Cl. B60W 60/00; G06F 16/435; G06F 16/45; G08G 1/00; G06N 20/00; G06F 16/487

(52) U.S. Cl. CPC B60W 60/001; G06F 16/435; G06F 16/487; G08G 1/202; G06N 20/00; G06F 16/45

(57) ABSTRACT

A vehicle navigation system may include a data pipeline that proposes routing graph modifications from automatically ingested data sources and that provides enough context to suggest an expiration time to remove the routing graph modifications once imposed. The system and method receives from at least one data source routing graph modification data including geographic location data identifying a location to which a routing graph modification applies. The routing graph modification data is associated with one or more roadway elements in a routing graph of a navigation constraints system, and the routing graph modification data associated with the one or more roadway elements is classified as a routing graph modification. The routing graph modification is added to or, if expired, removed from the navigation constraints system.

### CLAIM FOR PRIORITY

This application claims the benefit of priority of U.S. Application Ser. No. 63/031,178, filed May 28, 2020, which is hereby incorporated by reference in its entirety.

### TECHNICAL FIELD

This document pertains generally, but not by way of limitation, to devices, systems, and methods for operating an autonomous vehicle and, more particularly, to a routing system for autonomous vehicles that implements and manages routing graph modifications that specify an area that an autonomous vehicle may not enter due to construction and the like.

### BACKGROUND

An autonomous vehicle (AV) is a vehicle that is capable of sensing its environment and operating some or all of the vehicle's controls based on the sensed environment. An AV includes sensors that capture signals describing the environment surrounding the vehicle and a navigation system that responds to the inputs to navigate the AV along a travel route without human input. In particular, an AV can observe its surrounding environment using a variety of sensors and can attempt to comprehend the environment by performing various processing techniques on data collected by the sensors. Given knowledge of its surrounding environment, the AV can determine an appropriate motion plan relative to a travel route through its surrounding environment.

The determination of a travel route along which an AV can navigate can be based at least in part on routing graph data. However, routing graph data is not always updated to reflect changing availability of different roadway elements. In addition, routing graph data does not always include additional information about particular events and/or conditions that may affect the navigational availability or preference of particular roadway elements in a geographic area.

### BRIEF SUMMARY OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 depicts an example system for controlling the navigation of an autonomous vehicle according to example embodiments of the present disclosure;

FIG. 2 depicts an example system for communicating routing graph data and routing graph modification data according to example embodiments of the present disclosure;

FIG. 3 depicts an example system for outputting routing graph modifications to AVs according to example embodiments of the present disclosure;

FIG. 4 depicts a first example aspect of routing graph data including roadway elements according to example embodiments of the present disclosure;

FIG. 5 depicts a second example aspect of routing graph data including roadway elements according to example embodiments of the present disclosure;

FIG. 6 is a generalized depiction of a Navigation Constraints System (NCS) that receives routing graphs and routing graph modifications;

FIG. 7(a) depicts an automated NCS according to example embodiments of the present disclosure;

FIG. 7(b) depicts a sample embodiment including a machine learning model placed after the conflation engine of FIG. 7(a) to process the conflated data to determine whether the data may or may not be classified as a routing graph modification.

FIG. 8(a) illustrates an example of a DBSCAN where minPts=4;

FIG. 8(b) illustrates density-connected clusters defining routing graph modifications 1 and 2;

FIG. 9 illustrates a sample interface for an NCS illustrating a routing graph visualization, a routing graph modification metadata panel, and a perception data display area for displaying the routing graph and routing graph modification data;

FIG. 10(a) illustrates a sample interface through which one or more routing graph modifications (e.g., routing graph modifications 1 and 2 from FIG. 8(b)) can be proposed based on the automated processing of the received source data;

FIG. 10(b) illustrates the sample interface of FIG. 10(a) configured to enable routing graph modification 1 to be selected for editing;

FIG. 10(c) illustrates the sample interface of FIG. 10(a) configured to enable the status of a routing graph modification can be changed from “unverified” to “verified” by a human operator;

FIG. 11 depicts an example flow chart of an example method for automatically generating proposed routing graph modifications according to example embodiments of the present disclosure;

FIG. 12 depicts an example flow chart of a first example method of controlling navigation of an autonomous vehicle according to example embodiments of the present disclosure;

FIG. 13 depicts an example flow chart of a method of determining a travel route for an autonomous vehicle according to example embodiments of the present disclosure;

FIG. 14 depicts an example flow chart of a second example method of controlling navigation of an autonomous vehicle according to example embodiments of the present disclosure;

FIG. 15 depicts an example system for providing up-to-date route routing graph modification information to autonomous vehicles according to example embodiments of the present disclosure;

FIG. 16 depicts an example flow chart of a method of providing up-to-date route routing graph modification information to autonomous vehicles according to example embodiments of the present disclosure;

FIG. 17 is a block diagram illustrating a computer system upon which example AV processing systems described herein may be implemented; and

FIG. 18 is a block diagram that illustrates a computer system upon which examples described herein may be implemented.

### DESCRIPTION

Reference now will be made in detail to embodiments, one or more example(s) of which are illustrated in the drawings. Each example is provided by way of explanation of the embodiments, not limitation of the present disclosure. It will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

In an autonomous or semi-autonomous vehicle (collectively referred to as an autonomous vehicle (AV)), a vehicle autonomy system, sometimes referred to as an AV stack, controls one or more of braking, steering, or throttle of the vehicle. In a fully autonomous vehicle, the vehicle autonomy system assumes full control of the vehicle. In a semi-autonomous vehicle, the vehicle autonomy system assumes a portion of the vehicle control, with a human user (e.g., a vehicle operator) still providing some control input. Some autonomous vehicles can also operate in a manual mode, in which a human user provides all control inputs to the vehicle.

A vehicle autonomy system can control an autonomous vehicle along a route. A route is a path that the autonomous vehicle takes, or plans to take, over one or more roadways. The route for an autonomous vehicle is generated by a routing engine, which can be implemented onboard the autonomous vehicle or offboard the autonomous vehicle. The routing engine can be programmed to generate routes that optimize the time, danger, and/or other factors associated with driving on the roadways.

In some examples, the routing engine generates a route for the autonomous vehicle using a routing graph. The routing graph is a graph that represents roadways as a set of graph elements. A graph element is a component of a routing graph that represents a roadway element on which the autonomous vehicle can travel. A graph element can be or include an edge, node, or other component of a routing graph. A graph element represents a portion of roadway, referred to herein as a roadway element. A roadway element is a component of a roadway that can be traversed by a vehicle.

A roadway element be or include different subdivisions of a roadway, depending on the implementation. In some examples, the roadway elements are or include roadway segments. A roadway segment is a portion of roadway including all lanes and directions of travel. Consider a four-lane divided highway. A roadway segment of the four-lane divided highway includes a stretch of the highway including all four lanes and both directions of travel.

In some examples, roadway elements are or include directed roadway segments. A directed roadway segment is a portion of roadway where traffic travels in a common direction. Referring again to the four-lane divided highway example, a stretch of the highway would include at least two directed roadway segments: a first directed roadway segment including the two lanes of travel in one direction and a second directed roadway segment including the two lanes of travel in the other direction.

In some examples, roadway elements are or include lane segments. A lane segment is a portion of a roadway including one lane of travel in one direction. Referring again to the four-lane divided highway example, a portion of the divided highway may include two lane segments in each direction. Lane segments may be interconnected in the direction of travel and laterally. For example, a vehicle traversing a lane segment may travel in the direction to travel to the next connected lane segment or may make a lane change to move laterally to a different lane segment.

The routing graph includes data describing directionality and connectivity for the graph elements. The directionality of a graph element describes limitations (if any) on the direction in which a vehicle can traverse the roadway element corresponding to the graph element. The connectivity of a given graph element describes other graph elements to which the autonomous vehicle can be routed from the given graph element.

The routing graph can also include cost data describing costs associated with graph elements. The cost data indicates a cost to traverse a roadway element corresponding to a graph element or to transition between roadway elements corresponding to connected graph elements. Cost can be based on various factors including, for example, estimated driving time, danger risk, etc. In some examples, higher cost generally corresponds to more negative characteristics of a graph element or transition (e.g., longer estimated driving time, higher danger risk, etc.).

The routing engine determines a best route, for example, by applying a path-planning algorithm to the routing graph. Any suitable path-planning algorithm can be used, such as, for example, A*, D*, Focused D*, D* Lite, GD*, or Dijkstra's algorithm. The best route includes a string of connected graph elements between a vehicle start point and a vehicle end point. A vehicle start point is a graph element corresponding to the roadway element where a vehicle will begin a route. A vehicle end point is a graph element corresponding to the roadway element where the vehicle will end a route. Some routes also traverse one or more waypoints, where a waypoint is a graph element between the vehicle start point and the vehicle end point corresponding to a roadway element that the autonomous vehicle is to traverse on a route. In some examples, waypoints are implemented to execute a transportation service for more than one passenger or more than one cargo. For example, passengers and/or cargo may be picked up and/or dropped off at some or all of the waypoints. The best route identified by the path-planning algorithm may be the route with the lowest cost (e.g., the route that has the lowest cost or the highest benefit).

In various examples, it is desirable to configure a routing engine to cope with roadway conditions, vehicle capabilities, and sometimes even business policy preferences. For example, if a portion of a roadway is closed for construction, it is desirable that the routing engine avoid routing the autonomous vehicle through graph elements that correspond to the closed portion. Also, it is desirable that the routing engine avoid routing an autonomous vehicle through graph elements that include maneuvers that the autonomous vehicle is not capable of making. Further, it may be desirable for the routing engine to avoid routing autonomous vehicles through graph elements selected according to business policies, such as, for example, graph elements corresponding to roadway elements that are in school zones.

A routing graph can be constructed in view of different roadway conditions, vehicle capabilities, and/or policy preferences. For example, if a roadway condition makes a roadway element corresponding to a particular graph element impassable or less desirable, this can be reflected in the routing graph. For example, the routing graph may be constructed to omit the graph element, omit connectivity data describing transitions to and/or from the graph element, or increase a cost of traversing or transitioning to the graph element, etc.

Generating a custom routing graph for each unique permutation of roadway conditions, vehicle capabilities, policy preferences, or other considerations, however, can be costly and inefficient. For example, in some implementations a routing engine can be implemented centrally to generate routes for many different types of autonomous vehicles. Using a distinct routing graph for each type of vehicle can lead to inefficiencies related to data storage, data management, and other factors. Also, roadway conditions can change over time. Modifying a routing graph every time that there is a change in a roadway condition can be cumbersome. Also, it may be desirable to modify business policies over time and, sometimes, even for different vehicle types. Again, modifying routing graphs for every business policy change can be cumbersome and inefficient.

Various examples described herein are directed to routing autonomous vehicles utilizing a routing graph and routing graph modification data. The routing graph is a general-purpose routing graph that is usable for different types of autonomous vehicles, different business policies, and/or different roadway conditions. Routing graph modification data can be applied to the general-purpose routing graph either before or during routing to generate a constrained routing graph. A routing engine applies the constrained routing graph to generate routes for a particular type of autonomous vehicle, a particular set of roadway conditions, a particular set of policies, etc. Further, if roadway conditions, vehicle capabilities, policies, etc. change, it may not be necessary to create new routing graphs. Instead, routing graph modification data is created and/or modified to reflect changes.

Routing graph modification data can describe one or more routing graph modifications. A routing graph modification is a change to a routing graph (e.g., a general-purpose routing graph) that reflects various factors including, for example, capabilities of the vehicle that is to execute a route, current roadway conditions, business policy considerations, and so on. A routing graph modification includes a graph element descriptor and a constraint.

A graph element descriptor is data describing one or more graph elements that are the subject of a routing graph modification. For example, a graph element descriptor can describe graph elements using one or more graph element properties. A graph element property is anything that describes a graph element and/or its corresponding roadway element. Example graph element properties include, for example, a unique identifier for the graph element, a roadway type of the corresponding roadway element (e.g., divided highway, urban street, etc.), a driving rule of the roadway element associated with the graph element (e.g., speed limit, access limitations), a type of maneuver necessary to enter, exit, and/or traverse the corresponding roadway element, whether the corresponding roadway element leads to a specific type of roadway element (e.g., dead end, divided highway, etc.), and so on.

In some examples, a graph element descriptor is expressed as a predicate. A predicate is a question that has a binary answer. For example, a graph element descriptor expressed as a predicate may identify a predicate graph element property. If a graph element is described by the predicate graph element property, then the constraint is applied to that graph element. An example predicate graph element descriptor may include an assertion that a graph element has a speed limit greater than 35 miles per hour (mph). The constraint may be applied to graph elements that are described by the predicate graph element descriptor and not applied to graph elements that are not described by the predicate graph element.

A constraint is an action applied to graph elements at a routing graph that are described by the graph element descriptor of a routing graph modification. Example constraints that may be applied to a graph element include removing the graph element from the routing graph, modifying (e.g., removing) transitions to or from a graph element, changing a cost associated with a graph element or transitions involving the graph element, etc. Another example routing graph modification can include changing a required or recommended autonomous vehicle mode. For example, a graph element can be modified to indicate that an autonomous vehicle traversing the roadway element corresponding to the graph element should be operated in a semi-autonomous or manual mode.

Example aspects of the present disclosure are directed to systems and methods that control navigation of autonomous vehicles in accordance with constraint data that identifies geographic areas for inclusion and/or exclusion as permissible areas for navigation by the autonomous vehicles. As described herein, the routing graph modification data can include routing graph modifications that are implemented in a navigation system to identify one or more roadway segments to which navigation is prohibited or limited due to construction, closures, and the like. A constraint tool can be used by navigation system operators to automatically or semi-automatically create, edit, and deploy the routing graph modification data. In particular, the systems and methods of the present disclosure can obtain routing graph modification data descriptive of one or more geographic identifiers and an application type associated with each geographic identifier. Routing graph modification data can be received, for example, from one or more data sources including remote computing devices configured to control operation of a fleet of autonomous vehicles. Routing graph data descriptive of the identity and location of different roadway elements within the surrounding environment of the autonomous vehicle can be accessed and evaluated relative to the routing graph modification data in order to determine a travel route for navigating the autonomous vehicle. Motion of the autonomous vehicle then can be controlled based at least in part on the determined travel route.

The disclosed systems and methods can provide a system for automatically or semi-automatically providing routing graph modifications in order to effectively manage autonomous vehicles. As used herein, a routing graph modification includes (i) a graph element descriptor and (ii) a constraint. The graph element descriptor describes one or more graph elements that are subject to the routing graph modification. The constraint is the actual change to the routing graph (i.e., change the cost of the graph elements, eliminate the connectivity of the graph elements, etc.). A routing graph modification is thus a combination of an effect (what the constraint does) and where the constraint applies, which is the smallest atomic unit of the navigation constraints system described herein.

More particularly, an autonomous vehicle (e.g., a ground-based vehicle, air-based vehicle, other vehicle type) can include a vehicle computing system that implements a variety of systems including the navigation constraints system described herein. For instance, the vehicle computing system can include one or more sensors (e.g., image capture devices, RADAR devices, LIDAR devices, etc.), one or more computing devices for determining autonomous navigation, and one or more vehicle control system(s) (e.g., for controlling braking, steering, powertrain). The sensor(s) can be configured to obtain sensor data used to detect object(s) including, for example, pedestrians that are located within the travel route (e.g., roadway) of the autonomous vehicle, traveling in an adjacent roadway element (e.g., on a sidewalk, a running path), etc. The sensor data can be indicative of locations associated with the object(s) within the surrounding environment of the autonomous vehicle at one or more time(s). The sensor data can be provided to one or more computing devices in the vehicle computing system.

In addition to the sensor data, the vehicle computing system can retrieve, access, or otherwise obtain routing graph data that provides other detailed information about the surrounding environment of the autonomous vehicle. The routing graph data can provide information regarding the identity and location of different roadway elements (e.g., roadway segments, roadway elements, parking lanes, turning lanes, bicycle lanes, or other portions of a particular roadway element). In some examples, roadway elements within accessed routing graph data can include one or more descriptors including, for example, a district identifier, a roadway element identifier, a start point for the roadway element, an end point for the roadway element, a directionality (e.g., direction of traffic flow), and/or connectivity identifiers for other roadway elements that are predecessors and/or successors to a given roadway element. Routing graph data can also include the identity and location of different items than roadway elements, including but not limited to buildings, maintenance/service locations for the autonomous vehicles, parking areas, traffic signs, traffic lights, traffic control devices, and/or any other routing graph data that provides information that assists the vehicle computing system in comprehending and perceiving its surrounding environment and its relationship thereto.

The vehicle computing system can be configured to determine travel routes for the autonomous vehicle based at least in part on the routing graph data. In some examples, travel routes can be determined in accordance with a navigational objective (e.g., traveling to a destination location to perform a service such as a rideshare service, delivery service, courier service, etc.). Because autonomy systems can rely on computer-based determination of travel routes as opposed to human determination, it can sometimes be desirable to implement routing graph modifications on particular roadway segments that should be either included and/or excluded as permissible for navigation. For example, it may be desirable to exclude specific roadway segments due to events such as a traffic accident, street fair, construction, or the like. Specific roadway segments may be included as permissible for navigation by particular autonomous vehicles that are assigned to perform services in a given area, thus affording efficient distribution of fleet resources.

In order to implement dynamic routing graph modifications, routing graph modification data can provide information descriptive of one or more geographic areas and/or geographic identifiers within routing graph data for which associated routing graph modifications are defined. In some examples, the routing graph modifications can change the cost of traversing a roadway element as well as excluding the roadway element from routes. In some examples, existing routing graph modification data can be provided at and obtained by one or more computing devices located on-board an autonomous vehicle. In some examples, the routing graph modification data can be received from one or more remote computing devices configured to control operation of a fleet of autonomous vehicles. Routing graph modification data can be the same for some or all vehicles in a fleet, or it can be customized per vehicle depending on factors such as the operation location, operating mode, etc. of each autonomous vehicle.

In sample embodiments, routing graph modification data can be provided in a variety of suitable formats for evaluation by an autonomous vehicle relative to accessible routing graph data. In some implementations, routing graph modification data can be descriptive of one or more geographic identifiers and an application type associated with each of the one or more geographic identifiers. Geographic identifiers can include, for example, one or more roadway element identifiers (corresponding to routing graph elements) indicative of at least a portion of one or more lanes within a particular roadway element, or other identifiers. In some instances, the application type can indicate either that an associated geographic area can be included in a permissible area for navigation by the autonomous vehicle or that it should be excluded from a permissible area for navigation by the autonomous vehicle.

For example, the application type associated with each geographic identifier can be selected from a predetermined group of application types (e.g., complete inclusion, complete exclusion, etc.). Partial inclusion or partial exclusion may be included as part of the cost changes. In another example, the application type can be selected as a value from within a range of possible application type values (e.g., a number selected from within a range of 0-10 with 0 being least permissible or least preferred and 10 being most permissible or most preferred). In another example, an application type can correspond to an associated cost factor for navigating in a particular geographic area. One or more computing devices associated with an autonomous vehicle can evaluate the associated cost to determine a travel route that minimizes a total cost based at least in part on the cost factor associated with the application type as well as optional additional cost factors, cost functions or the like. Depending on the manner of application type, travel routes can be determined that not only can exclude particular roadway segments from navigation but that change the cost of the routing graph elements/roadway elements.

In some examples, routing graph modification data can be determined, evaluated or otherwise considered by a vehicle computing system based on a current mode of operation for an autonomous vehicle. Different modes of operation can include, for example, a fully autonomous mode in which the autonomous vehicle operates without a human driver present in the vehicle, an autonomous mode in which the autonomous vehicle operates with a human driver in the vehicle, or other modes. In some implementations, routing graph modification data can include a priori routing graph modifications identifying that an autonomous vehicle should be excluded from making a left hand turn in particular turn lanes of a given roadway element or roadway element when a vehicle is operating in a particular mode. Different modes of operation can additionally or alternatively include, for example, whether a vehicle is currently engaged or not engaged in performing a service. For instance, some vehicles may currently have passengers on board that are being driven from one location to another, while other vehicles may be engaged in controlled navigation but are not currently engaged in a particular operational task. Routing graph modification data may selectively include on-task autonomous vehicles to navigate in a particular area while excluding autonomous vehicles that are off-task.

Composite routing graph modification data can be generated by modifying existing routing graph modification data accessed by an autonomous vehicle based at least in part on one or more routing graph modification files received, for example, from one or more remote computing devices remote from the autonomous vehicle. The one or more routing graph modification files can be descriptive of additional routing graph modifications for one or more geographic areas and/or geographic identifiers. For example, each routing graph modification file may include a routing graph modification set including zero or more geographic identifiers as well as a default state indicating whether to by default permit or forbid roadway segments described by the routing graph modification file. The application type associated with each geographic identifier can describe how to evaluate the geographic identifier relative to routing graph data.

After an autonomous vehicle obtains routing graph modification data, one or more computing systems located on-board or off-board the autonomous vehicle can determine a travel route for navigating the autonomous vehicle. The travel route can be determined at least in part from routing graph data that is evaluated relative to the composite routing graph modification data. For example, the routing graph data can be evaluated in association with the composite routing graph modification data to determine which roadway elements are permitted and which roadway elements are forbidden. A travel route can be determined that never incorporates a forbidden roadway element. The determined travel route can include, for example, a sequence of multiple roadway elements along which an autonomous vehicle can navigate, for example, to accomplish a predetermined navigational objective. Each roadway element within a determined travel route can be defined by one or more of a roadway element identifier, a start point, an end point, a directionality, and/or connectivity identifiers for predecessor and/or successor roadway elements.

Once a travel route is determined, a vehicle computing system can determine a motion plan to control motion of the autonomous vehicle along the determined travel route. The motion plan can be further based on any objects proximate to the autonomous vehicle (e.g., pedestrians, other vehicles, traffic control devices, etc.) that are detected by the vehicle's sensors, image capture devices, or other data acquisition system components. For instance, the vehicle computing system can be a computing system that includes various sub-systems that cooperate to perceive the surrounding environment of the autonomous vehicle and determine a motion plan for controlling the motion of the autonomous vehicle. For instance, the vehicle computing system can include a perception system, a prediction system, and a motion planning system.

In other implementations of the disclosed systems and methods, one or more remote computing devices can be configured to implement systems and method of controlling operation of one or more autonomous vehicles. In some examples, such remote computing device(s) can be included as part of a central control system that is in wireless communication with a plurality of autonomous vehicles, such as a fleet of autonomous vehicles providing one or more services (rideshare service, delivery service, courier service, etc.). The one or more remote computing devices can create a routing graph modification set with zero or more geographic identifiers and a default state (e.g., permit or forbid) that indicates whether to by default permit or forbid roadway segments or instruct the autonomous vehicle to immediately depart the area described by the routing graph modification file. The one or more remote computing devices can identify an event at some geographic location that will impact navigation at such location (e.g., a street fair, sporting event, traffic accident, bridge closure, parade, etc.). The one or more remote computing devices can then determine routing graph modification data associated with the identified event. The one or more remote computing devices then can assign the one or more geographic identifiers to the routing graph modification set and transmit the routing graph modification data to one or more autonomous vehicles over a network.

Identification of events for which the disclosed routing graph modification data can be determined can come from data descriptive of an upcoming event (e.g., sporting event, bridge closure, parade, or the like) and/or historical data (e.g., by approximating navigational limitations based on past events in a particular geographic region at a certain time and/or date). The one or more remote computing devices can utilize various databases to predict, approximate, and/or determine the events and/or geographic locations of anticipated navigational limitations. For example, for different geographic regions, event information (e.g., location, time, and/or date of the event, or the like) can be stored in an event database. Event information can be indicative of whether traffic can be higher or lower at a certain time period (e.g., a time period before the event begins versus a time period when the event is ongoing). In another example, event information can come from calendar databases that indicate important dates (e.g., holidays, first days of school for a city, voting day, or the like). Other examples of outside sources or other stored data (e.g., predicted future, current and/or historic events, conditions, or the like) include weather conditions, news information (e.g., fires, emergency situations, or the like), social information (e.g., via social networking websites), traffic conditions, flight information from airports and/or airlines, or the like, construction information from municipal sources, routing data from other fleet managed vehicles, or other information that can assist in determining event information, traffic patterns or other data contributing to potential routing graph modifications.

The systems, methods, and vehicles described herein may provide a number of technical effects and benefits. For instance, the vehicle computing system can locally (e.g., on-board the vehicle) obtain routing graph modification data, evaluate routing graph data relative to the routing graph modification data, and determine a travel route for navigating the autonomous vehicle in compliance with the routing graph modification data. By performing such operations on-board the autonomous vehicle, the vehicle computing system can avoid certain latency issues that arise by reliance on a remote computing system for off-board operations. For example, the vehicle computing system can be configured to initialize and update its travel route(s) based on obtained routing graph modification data and accessible routing graph data as opposed to waiting for determined travel routes to be approved or disapproved by a central command or other remote computing device/system. As such, routing graph data can be evaluated relative to routing graph modification data and travel routes can be determined with increased computational efficiency.

The systems, methods, and vehicles described herein have an additional technical effect and benefit of providing a flexible and customizable approach to defining included and/or excluded geographic areas for navigation by an autonomous vehicle. By communicating routing graph modifications to an autonomous vehicle from one or more remote computing devices, a fleet operator associated with the remote computing devices is afforded flexibility in controlling navigation. Fleet operators have the flexibility of sending instructions to an entire fleet of vehicles operating in a given geographic area, to just one autonomous vehicle, or to a subset of vehicles. Fleet operators can provide inclusion areas and/or exclusion areas to an autonomous vehicle in real time or near real time to account for numerous dynamically changing events (e.g., a traffic accident, construction, street fair, parade, bridge closure, etc.) and/or specific modes of operation (e.g., operation of the autonomous vehicle with or without human drivers). This dynamic approach helps autonomous vehicles adjust their travel routes in real time or near real time without having to regenerate limitations within routing graph data or require autonomous vehicles to return to a central command center to upload new routing graphs.

The systems, methods, and vehicles described herein have yet another technical effect and benefit of providing an automated or semi-automated approach to updating the routing graph modification data by providing evidence of a routing graph modification to a human operator or a machine learning classification model and automatically expiring routing graph modifications when the routing graph modification is identified as expiring and sufficient evidence of the removal of the routing graph modification is identified. For example, municipal data may indicate that a road construction project is to effect certain roadway segments from May 1, 2020 to Jun. 1, 2020. Perception data received from vehicles traveling in the area of the road construction project can be used to verify that the roadway segments are closed from May 1, 2020 to Jun. 1, 2020 and that the road construction has been timely completed on Jun. 1, 2020 and the blockages of the roadway segments removed.

In some implementations, routing graph modification data can be defined that is customized based on location in order to account for roadway element design, operational parameters, events, etc. that are different from city to city, country to country or the like.

The systems, methods, and vehicles described herein have an additional technical effect and benefit of providing more efficient navigation while simultaneously enhancing the safety and security of autonomous vehicles, passengers and/or cargo. By providing a mechanism to obtain routing graph modification data, autonomous vehicles can benefit from the knowledge of when and where potential problem areas may exist for travel routes. A vehicle computing system can determine optimized travel routes or update travel routes in an enhanced manner by evaluating routing graph data relative to current routing graph modification data in order to avoid exclusion roadway segments. By planning ahead to avoid such roadway segments, the potential for navigational back-tracking is reduced. In addition, by avoiding exclusion roadway segments that are identified because of certain events (e.g., traffic accidents, protestor demonstrations, parades, bridge closures, etc.), the safety of vehicles, passengers, and/or cargo can be increased.

The systems, methods, and vehicles described herein also provide an improvement to vehicle computing technology, such as autonomous vehicle computing technology. For instance, aspects of the present disclosure enable a vehicle computing system to more efficiently and accurately control the vehicle's motion. By planning which roadway elements (e.g., turn lanes, narrow lanes, lanes with blind spots, etc.) that an autonomous vehicle should use or avoid based in part on obtained routing graph modification data, motion plans can be determined in advance along an ideal travel route. Improved autonomy and effective determination of a vehicle travel route and motion plan can be a primary factor in achieving enhanced overall operation of an autonomous vehicle.

During normal fleet operations of autonomous vehicles, it may become necessary to react to changes to the operating environment that restrict the valid operating environment for the autonomous vehicles. These changes are often transient in nature and thus are not desirable to be included in the routing graph. Examples range from construction zones, to sinkholes, to parades. The primary tools for addressing such changes is to employ Forbid Routing (FBR) (an effect that completely prevents (excludes) routing on the affected roadway segments) and High Cost/Avoid (HCA) (an effect that causes the affected roadway segments to be “more expensive” to traverse whereby the affected routes would be less likely to be traversed over the affected roadway segments) routing graph modifications. Other routing graph modifications may include forced manual from Auto/Routable Non-Auto (RNA) where RNA lanes can be used to route but only for manual driving. By using the navigation constraints system described herein, operators may automatically or semi-automatically annotate the routing graph dynamically and alter the routing behavior of one or more autonomous vehicles. By way of example only, the routing systems described in U.S. patent application Ser. Nos. 16/752,199 and 16/752,242 are exemplary and are incorporated herein by reference.

A Navigation Constraints System (NCS) as described herein is the primary tool used in order to decide where in a roadway segment graph it is permissible for a route to traverse, as well as what mode the AV should be in while it traverses the route. The NCS can be utilized by operators in order to affect the behavior of an autonomous vehicle fleet dynamically, but it also may be used to block off certain portions of the routing graph of an autonomous vehicle that may not be used due to organizational policies or autonomy capabilities.

However, there are limitations to these NCS tools in certain operating environments. For example, High Cost/Avoid is merely a suggestion. It will, on average, cause the autonomous vehicle(s) to avoid an area, but it will not prevent them from entering it. On the other hand, Forbid Routing (FBR) is an absolute. Autonomous vehicles will never traverse roadway elements marked as FBR, for any reason. This becomes especially problematic in an autonomous vehicle setting where there is no human operator as it is possible that routing graph modifications may be applied that will strand the autonomous vehicle by constraining travel in the area the autonomous vehicle is currently occupying. In this situation, the only safe thing the autonomous vehicle can do is to perform a safe stop, because it must assume that the FBR routing graph modification was applied for a reason, and it is no longer safe to continue traversing that area. Techniques for addressing this issue are described in U.S. patent application Ser. No. 16/538,275, the contents of which are incorporated herein by reference.

Another limitation to these NCS tools is that the routing graph modification data is typically created manually by human operators using a web-based routing graph modifications tool. The manual creation and application of the routing graph modification data leads to problems with low coverage (routing graph modifications are added too late), the routing graph modifications quickly becoming stale (not removed fast enough), subject to human error, and routing graph dependent (using roadway element IDs and the like). An automated mechanism for updating the routing graph modification data in a timely fashion is desired.

The inventors have recognized that multiple data sources are readily available that may be used as evidence of potential routing graph modifications and that data from these data sources may be automatically processed to identify potential routing graph modifications. In sample embodiments, the routing graph modifications management workflow is modified to include a data pipeline that proposes routing graph modifications from automatically ingested data sources and that provides enough context to suggest an expiration time to remove the routing graph modifications once imposed. The resulting routing graph modifications management system increases the accuracy of the coverage of the routing graph modifications and increases the recency of the routing graph modifications by providing for more timely removal of any imposed routing graph modifications. In sample embodiments, the evidence and routing graph modifications may be represented independently of the routing graph version and may provide more context for human quality assurance for validation of any proposed new routing graph modifications or proposed routing graph modification removal.

In sample embodiments, the management of routing graph modifications for a vehicle navigation system is modified to include a data pipeline that proposes routing graph modifications from automatically ingested data sources and that provides supporting context information to suggest an expiration time to remove the routing graph modifications once imposed. The system and method receives from at least one data source routing graph modification data including geographic location data (e.g. roadway segments) identifying a location to which a routing graph modification applies. The data source(s) can include a municipal data source, a traffic data source, routing/dispatch data from a routing/dispatch system, and/or perception data collected by an autonomous vehicle. The routing graph modification data is associated with one or more roadway elements in a routing graph of a navigation constraints system, and the routing graph modification data associated with the one or more roadway elements is classified as a routing graph modification. The routing graph modification is added to or, if expired, removed from the navigation constraints system.

The sample embodiments described herein include a navigation constraints system that controls navigation of an autonomous vehicle. The navigation control system includes a memory that stores instructions and one or more processors that execute the instructions from the memory to perform operations including receiving routing graph modification data from at least one data source, the routing graph modification data including geographic location data identifying a location to which a routing graph modification applies. The at least one data source can includes a municipal data source, a traffic data source, routing/dispatch data from a routing/dispatch system, and/or perception data collected by an autonomous vehicle. The routing graph modification data is associated with one or more roadway elements in a navigational routing graph, and the evaluation of the routing graph modification data associated with the one or more roadway elements is enabled whereby the routing graph modification data is classified as a routing graph modification associated with the one or more roadway elements. A travel route for navigating the autonomous vehicle is determined based at least in part on navigational routing graph data evaluated relative to the routing graph modification associated with the one or more roadway elements, and motion of the autonomous vehicle is controlled based at least in part on the determined travel route.

In sample embodiments, the routing graph modification data from the at least one data source can include timing data indicating a duration of a routing graph modification. In such case, the one or more processors further execute the instructions to associate a routing graph modification expiration time with the routing graph modification. The one or more processors may further execute the instructions to remove an expired routing graph modification or to trigger a refresh of routing graph modification data of the navigation constraints system when the routing graph modification expiration time has been reached.

In further sample embodiments, an evidence storage is provided, and the one or more processors further execute the instructions to standardize representations of the routing graph modification data from the at least one data source and to store standardized representations of the routing graph modification data in the evidence storage. A clustering algorithm can be provided for execution by the one or more processors to cluster the routing graph modification data by geographic location and to cluster routing graph modification data to the one or more roadway elements in the routing graph. The one or more processors can further execute the instructions to associate the clustered routing graph modification data mapped to the one or more roadway elements in the routing graph with supporting context data including metadata and/or video. In sample embodiments, the clustering algorithm can be a k-means clustering algorithm or a density-based spatial clustering of applications with noise (DBSCAN) clustering algorithm.

In additional sample embodiments, a display interface can be provided to display the clustered routing graph modification data mapped to the one or more roadway elements in the routing graph and the supporting context data to enable a human to provide inputs via the display interface to classify the routing graph modification data as the routing graph modification associated with the one or more roadway elements. Alternatively, a machine learning classification model (e.g., of a support vector machine or a neural network) can be provided that receives routing graph modification data associated with one or more roadway elements in the routing graph and classifies the routing graph modification data as a routing graph modification associated with the one or more roadway elements. The machine learning classification model can be adapted to feedback weighting data to weight the routing graph modification data received from respective data sources of the at least one data source to provide supervised learning.

The disclosure described herein further describes a corresponding method and computer-readable media for controlling navigation of an autonomous vehicle.

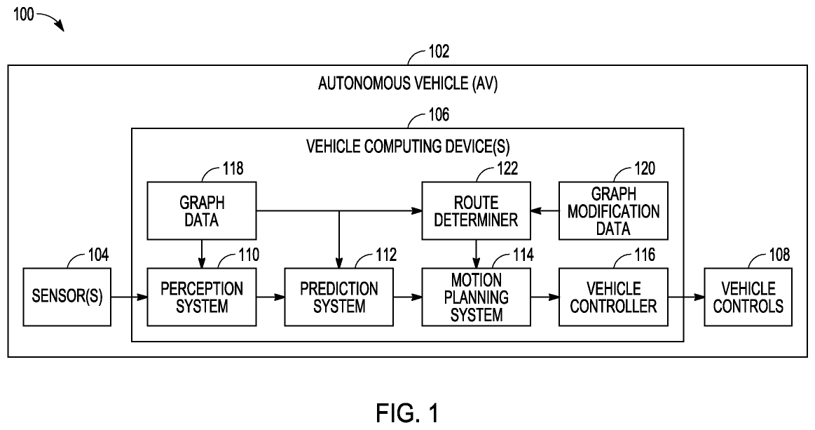

With reference now to the Figures, example embodiments of the present disclosure will be discussed in further detail. FIG. 1 depicts an example vehicle computing system 100 of an autonomous vehicle 102 according to example embodiments of the present disclosure. The autonomous vehicle 102 incorporating the vehicle computing system 100 can be a ground-based autonomous vehicle (e.g., car, truck, bus), an air-based autonomous vehicle (e.g., airplane, drone, helicopter, or other aircraft), or other type of vehicles (e.g., watercraft). The autonomous vehicle 102 can be configured to drive, navigate, operate, etc. with minimal and/or no interaction from a human driver. For example, the autonomous vehicle 102 can be configured to operate in one or more mode(s) such as, for example, a fully autonomous operational mode and/or a semi-autonomous operational mode. A fully autonomous (e.g., self-driving) operational mode can be one in which the autonomous vehicle 102 can provide driving and navigational operation with no interaction from a human driver. A semi-autonomous operational mode can be one in which the autonomous vehicle 102 can operate with some interaction from a human driver present in the vehicle. In some implementations, the autonomous vehicle 102 can be associated with an entity (e.g., a service provider) that provides one or more vehicle service(s) to a plurality of users via a fleet of vehicles that includes, for example, the autonomous vehicle 102. The vehicle service(s) can include transportation services (e.g., rideshare services), courier services, delivery services, and/or other types of services. The vehicle service(s) can transport and/or deliver passengers as well as items such as but not limited to food, animals, freight, purchased goods, etc.

As further illustrated in FIG. 1, the vehicle computing system 100 can include one or more sensors 104, one or more computing devices 106 and one or more vehicle controls 108. One or more of these systems can be configured to communicate with one another via a communication channel. The communication channel can include one or more data buses (e.g., controller area network (CAN)), diagnostics connector (e.g., OBD-11), and/or a combination of wired and/or wireless communication links.

Any on-board systems can send and/or receive data, messages, signals, etc. amongst one another via the communication channel. The one or more computing devices 106 can include a perception system 110, a prediction system 112, and a motion planning system 114 that cooperate to perceive the surrounding environment of the autonomous vehicle 102 and to determine a motion plan for controlling the motion of the autonomous vehicle 102 accordingly.

In particular, in some implementations, the perception system 110 can receive sensor data from the one or more sensors 104 that are coupled to or otherwise included within the autonomous vehicle 102. As examples, the one or more sensors 104 can include a Light Detection and Ranging (LIDAR) system, a Radio Detection and Ranging (RADAR) system, one or more cameras (e.g., visible spectrum cameras, infrared cameras, etc.), and/or other sensors. The sensor data can include information that describes the location of objects within the surrounding environment of the autonomous vehicle 102 (e.g., at one or more times).

As one example, for a LIDAR system, the sensor data from sensor(s) 104 can include the location (e.g., in three-dimensional space relative to the LIDAR system) of a number of points that correspond to objects that have reflected a ranging laser. For example, a LIDAR system can measure distances by measuring the Time of Flight (TOF) that it takes a short laser pulse to travel from the sensor to an object and back, calculating the distance from the known speed of light.

As another example, for a RADAR system, the sensor data from sensor(s) 104 can include the location (e.g., in three-dimensional space relative to the RADAR system) of a number of points that correspond to objects that have reflected a ranging radio wave. For example, radio waves (pulsed or continuous) transmitted by the RADAR system can reflect off an object and return to a receiver of the RADAR system, giving information about the object's location and speed. Thus, a RADAR system can provide useful information about the current speed of an object.

As yet another example, for one or more cameras, various processing techniques (e.g., range imaging techniques such as, for example, structure from motion, structured light, stereo triangulation, and/or other techniques) can be performed to identify the location (e.g., in three-dimensional space relative to the one or more cameras) of a number of points that correspond to objects that are depicted in imagery captured by the one or more cameras. Other sensor systems can identify the location of points that correspond to objects as well.

Thus, the one or more sensors 104 can be used to collect sensor data that includes information that describes the location (e.g., in three-dimensional space relative to the autonomous vehicle 102) of points that correspond to objects within the surrounding environment of the autonomous vehicle 102.

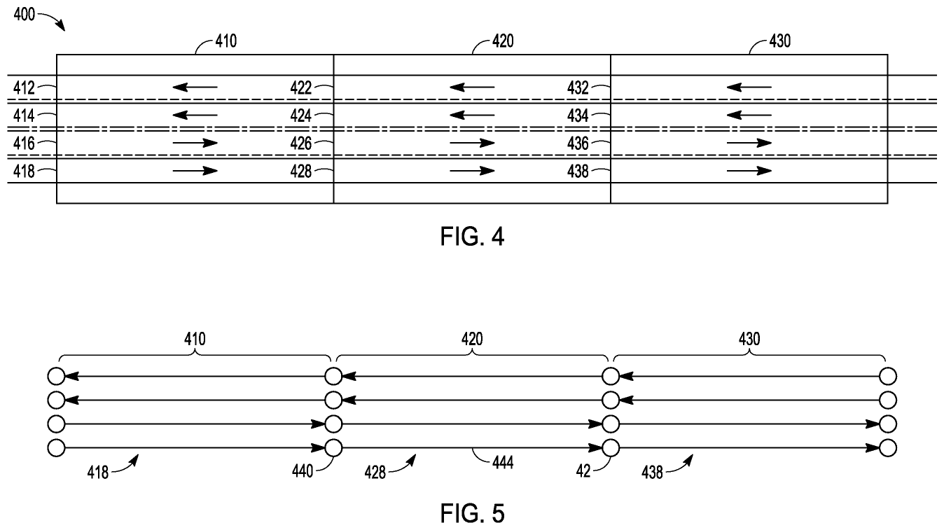

In addition to the sensor data, the computing device(s) 106 can retrieve or otherwise obtain routing graph data 118 that provides detailed information about the surrounding environment of the autonomous vehicle 102. The routing graph data can provide information regarding the identity and location of different roadway elements (e.g., roadway segments, roadway elements, parking lanes, turning lanes, bicycle lanes, or other portions of a particular roadway element). In some examples, roadway elements within accessed routing graph data can include one or more descriptors including, for example, a roadway element identifier, a start point for the roadway element, an end point for the roadway element, a directionality (e.g., direction of traffic flow), and/or connectivity identifiers for other roadway elements that are predecessors and/or successors to a given roadway element. Routing graph data can also include the identity and location of different items than roadway elements, including but not limited to buildings, maintenance/service locations for the autonomous vehicles, parking areas, traffic signs, traffic lights, traffic control devices, and/or any other routing graph data that provides information that assists the computing system in comprehending and perceiving its surrounding environment and its relationship thereto. An example depiction of routing graph data 118 for given roadway elements is provided in FIGS. 4-5 and will be discussed below.

The computing device(s) 106 also can retrieve or otherwise obtain routing graph modification data 120 that provides information descriptive of one or more geographic areas and/or geographic identifiers within a routing graph for which associated routing graph modifications are defined. In some examples, routing graph modification data 120 can identify geographic areas within routing graph data 118 that should be included and/or excluded from permissible areas (or preferred and/or not preferred) for navigation by autonomous vehicle 102. For instance, routing graph modification data 120 can include instructions for excluding or reducing travel in specific areas or specific roadway elements within an area due to events such as a traffic accident, street fair, construction, parade, bridge closure, or the like. Routing graph modification data 120 can alternatively include instructions for including specific areas or specific roadway elements as permissible for navigation by particular autonomous vehicles assigned to perform services in a given area, thus affording efficient distribution of fleet resources.

The computing device(s) 106 can also include a route determiner 122 configured to determine travel routes for the autonomous vehicle 102 based at least in part on the routing graph data 118 evaluated relative to the routing graph modification data 120. In some examples, travel routes can be determined by route determiner 122 in accordance with a navigational objective (e.g., traveling to a destination location to perform a service such as rideshare service, delivery service, courier service, etc.). Route determiner 122 can evaluate the routing graph data 118 in association with the routing graph modification data 120 to determine which roadway elements are included and/or which roadway elements are excluded. The determined travel route can include, for example, a sequence of multiple permitted roadway elements along which an autonomous vehicle can navigate, for example, to accomplish a predetermined navigational objective. Each roadway element within a determined travel route can be defined by one or more of a roadway element identifier, a start point, an end point, directionality, and/or connectivity identifiers for predecessor and/or successor roadway elements.

The perception system 110 can identify one or more objects that are proximate to the autonomous vehicle 102 based on sensor data received from the one or more sensors 104 and/or the routing graph data 118. In particular, in some implementations, the perception system 110 can determine, for each object, state data that describes a current state of such object. As examples, the state data for each object can describe an estimate of the object's: current location (also referred to as position); current speed (also referred to as velocity); current acceleration; current heading; current orientation; size/footprint; class (e.g., vehicle versus pedestrian versus bicycle versus other); yaw rate; and/or other state information. In some implementations, the perception system 110 can determine state data for each object over a number of iterations. In particular, the perception system 110 can update the state data for each object at each iteration. Thus, the perception system 110 can detect and track objects (e.g., vehicles) that are proximate to the autonomous vehicle 102 over time.

The prediction system 112 can receive the state data from the perception system 110 and predict one or more future locations for each object based on such state data. For example, the prediction system 112 can predict where each object will be located within the next 5 seconds, 10 seconds, 20 seconds, etc. As one example, an object can be predicted to adhere to its current trajectory according to its current speed. As another example, other, more sophisticated prediction techniques or modeling can be used.

The motion planning system 114 can determine a motion plan for the autonomous vehicle 102 based at least in part on the travel route determined by route determiner 122 and/or the predicted one or more future locations for the object and/or the state data for the object provided by the perception system 110. Stated differently, given information about the current locations of objects and/or predicted future locations of proximate objects, as well as a predetermined travel route, the motion planning system 114 can determine a motion plan for the autonomous vehicle 102 that best navigates the autonomous vehicle 102 along the determined travel route relative to the objects at such locations.

As one example, in some implementations, the motion planning system 114 can determine a cost function for each of one or more candidate motion plans for the autonomous vehicle 102 based at least in part on the current locations and/or predicted future locations of the objects. For example, the cost function can describe a cost (e.g., over time) of adhering to a particular candidate motion plan. For example, the cost described by a cost function can increase when the autonomous vehicle 102 strikes another object and/or deviates from a preferred pathway (e.g., a predetermined travel route).

Thus, given information about the current locations and/or predicted future locations of objects, the motion planning system 114 can determine a cost of adhering to a particular candidate pathway. The motion planning system 114 can select or determine a motion plan for the autonomous vehicle 102 based at least in part on the cost function(s). For example, the motion plan that minimizes the cost function can be selected or otherwise determined. The motion planning system 114 can provide the selected motion plan to a vehicle controller 116 that controls one or more vehicle controls 108 (e.g., actuators or other devices that control gas flow, steering, braking, etc.) to execute the selected motion plan.

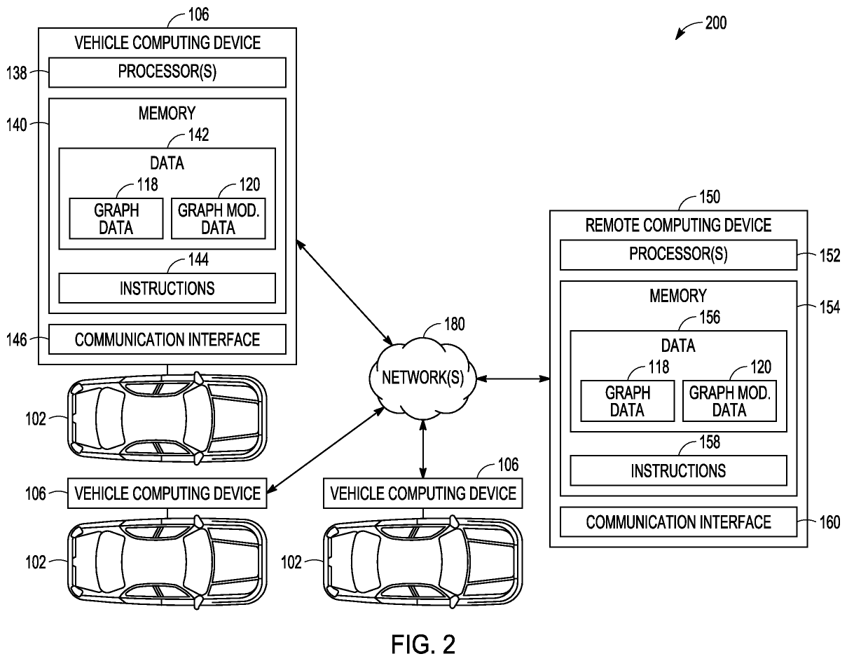

Each of the perception system 110, the prediction system 112, the motion planning system 114, the vehicle controller 116, and the route determiner 122 can include computer logic utilized to provide desired functionality. In some implementations, each of the perception system 110, the prediction system 112, the motion planning system 114, the vehicle controller 116, and the route determiner 122 can be implemented in hardware, firmware, and/or software controlling a general-purpose processor. For example, in some implementations, each of the perception system 110, the prediction system 112, the motion planning system 114, the vehicle controller 116 and the route determiner 122 includes program files stored on a storage device, loaded into a memory and executed by one or more processors. In other implementations, each of the perception system 110, the prediction system 112, the motion planning system 114, the vehicle controller 116, and the route determiner 122 includes one or more sets of computer-executable instructions that are stored in a tangible computer-readable storage medium such as RAM hard disk or optical or magnetic media, as is further described in FIG. 2.

FIG. 2 depicts a block diagram of an example computing system 200 according to example embodiments of the present disclosure. In particular, FIG. 2 illustrates an example implementation of the present disclosure in which one or more remote computing devices 150 are communicatively coupled with one or more vehicle computing devices 106 over a network 180. Each vehicle computing device 106 can be part of a vehicle computing system 100 associated with a particular autonomous vehicle 102. It should be appreciated that FIG. 2 illustrates only one example computing system 200 that can be used to implement the present disclosure. Other computing systems can be used as well.

Each vehicle computing device 106 can include one or more processors 138 and a memory 140. The one or more processors 138 can be any suitable processing device (e.g., a processor core, a microprocessor, an ASIC, a FPGA, a controller, a microcontroller, etc.) and can be one processor or a plurality of processors that are operatively connected. The memory 140 can include one or more non-transitory computer-readable storage mediums, such as RAM, ROM, EEPROM, EPROM, flash memory devices, magnetic disks, etc., and combinations thereof. The memory 140 can store data 142 and instructions 144 which are executed by the processor 138 to cause the vehicle computing device 106 to perform operations. Data 142 can include routing graph data 118 and routing graph modification data 120.

The vehicle computing device(s) 106 can obtain routing graph data 118 and/or routing graph modification data 120 via interaction with the remote computing device(s) 150 that are communicatively coupled over the network 180. The remote computing device(s) 150 can be separate from the vehicle computing device(s) 106 and provided in a location remote from the vehicle computing device(s) 106, for instance, in a central control system associated with a service provider, owner, and/or fleet operator controlling a fleet of autonomous vehicles 102.

The remote computing device(s) 150 can include one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the remote computing device(s) 150 to perform operations. The data 156 can include routing graph data 118 and routing graph modification data 120 that is relayed over network 180 to one or more vehicle computing devices 106 associated with respective autonomous vehicles 102.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL). In some examples, vehicle computing device(s) 106 and/or remote computing device(s) 150 can further include one or more communication interfaces 146, 160, including any suitable components (transmitters, receivers, ports, controllers, antennas, etc.) for interfacing with network 180 or one or more other networks.

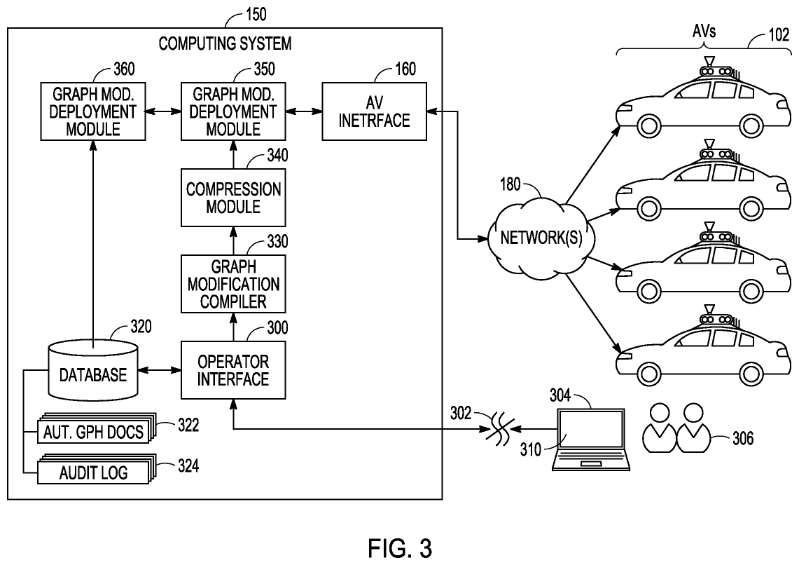

FIG. 3 depicts an example computer system for outputting routing graph modifications to AVs, according to example embodiments of the present disclosure. As illustrated, computing system 150 may be adapted to include AV communication interface 160 that communicates with a fleet of autonomous vehicles 102 via one or more networks 180. The computing system 150 further includes a fleet operator interface 300 connected over a network 302 with a computing device 304 operable by fleet operators 306. The computing device 304 can display a routing graph modification interface 310 enabling the fleet operators 306 to configure routing graph modifications to be merged into the autonomy routing graphs utilized by the autonomous vehicles 102. The computing system 150 can further include a database 320 storing autonomy routing graph documents 322 and audit logs 324, as described herein. The computing system 150 can further include a routing graph modification compiler 330, a compression module 340, and a routing graph modification deployment module 350. In certain aspects, the computing system can further include a conflict module 360 that assures a deployed document container does not conflict with other applicable policies and/or routing graph modifications, which may result in an error condition.

FIGS. 4-5 depict first and second example aspects of routing graph data 118, particularly routing graph data relative to the illustrated roadway elements, according to example embodiments of the present disclosure. As previously described, routing graph data 118 can include a wealth of information regarding the identity and location of different roadway elements (e.g., roadway segments, roadway elements, parking lanes, turning lanes, bicycle lanes, or other portions of a particular roadway element), buildings, maintenance/service locations for the autonomous vehicles, parking areas, traffic signs, traffic lights, traffic control devices, and/or any other routing graph data that provides information that assists the computing system in comprehending and perceiving its surrounding environment and its relationship thereto. The particular identifiers discussed in FIGS. 4-5 for representing routing graph data 118 can also be used to represent routing graph modification data 120 and/or travel routes determined by route determiner 122.

FIG. 4 illustrates that information about each roadway element within routing graph data 118 can be provided in detailed form. For instance, a portion of road 400 can be represented within routing graph data 118 as a plurality of roadway segments 410, 420, and 430. Each roadway segment can respectively include one or more roadway elements. In the example of FIG. 4, roadway segment 410 includes two roadway elements 412 and 414 associated with travel in a first direction and two roadway elements 416 and 418 associated with travel in a second direction (e.g., opposing the first direction). Roadway segment 420 includes two roadway elements 422 and 424 associated with travel in a first direction and two roadway elements 426 and 428 associated with travel in a second direction (e.g., opposing the first direction). Roadway segment 430 includes two roadway elements 432 and 434 associated with travel in a first direction and two roadway elements 436 and 438 associated with travel in a second direction (e.g., opposing the first direction).

Referring now to FIG. 5, each roadway element within routing graph data 118 can be defined using additional and/or alternative data than depicted in FIG. 4. For instance, each roadway element (e.g., roadway elements 412-418, 422-428, 432-438) can include a roadway element identifier, a roadway segment identifier, a roadway identifier, a district identifier, a start point, an end point, a directionality vector indicating a direction of traffic flow between start and end points, and/or connectivity identifiers for other roadway elements that are predecessors and/or successors thereto. For example, roadway element 428 can be defined using roadway element identifier 428, roadway segment identifier 420, roadway identifier 400, start point 440, end point 442, a directionality vector 444 indicating the direction of traffic flow between start point 440 and end point 442, and an indication that roadway element 428 is connected to predecessor roadway element 418 (of roadway segment 410) and successor roadway element 438 (of roadway segment 430).

In some implementations, routing graph data 118, routing graph modification data 120 and/or travel routes determined by route determiner 122 can be identified in terms of particular districts or coverage areas that include some or all of such data. For instance, roadway element identifiers such as described, for example, in FIGS. 4-5 can be additionally identified in terms of what district or coverage area they are included in. By breaking a routing graph down into different districts or coverage areas, the disclosed systems and methods can more easily identify which portions of routing graph data 118 need to be evaluated relative to routing graph modification data 120 to determine appropriate travel routes.

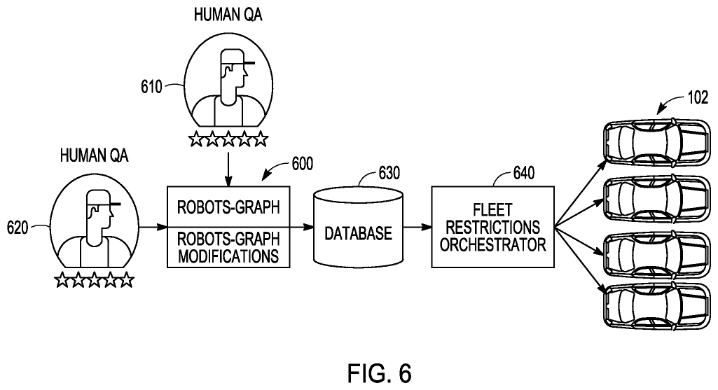

FIG. 6 is a generalized depiction of the NCS 600 that receives routing graphs and routing graph modifications. As illustrated, the NCS 600 receives routing graphs and routing graph modifications that are evaluated for quality assurance by human QAs 610 and 620. The updated routing graphs and routing graph modifications are stored in a database 630 and called up by a fleet restrictions orchestrator 640 during the process of creating proposed routing graphs for one or more fleet vehicles 102. As noted above, the manual creation and application of the routing graph modification data leads to problems with low coverage (routing graph modifications are added too late), the routing graph modifications quickly becoming stale (not removed fast enough), subject to human error, and routing graph dependent (using roadway element IDs and the like).

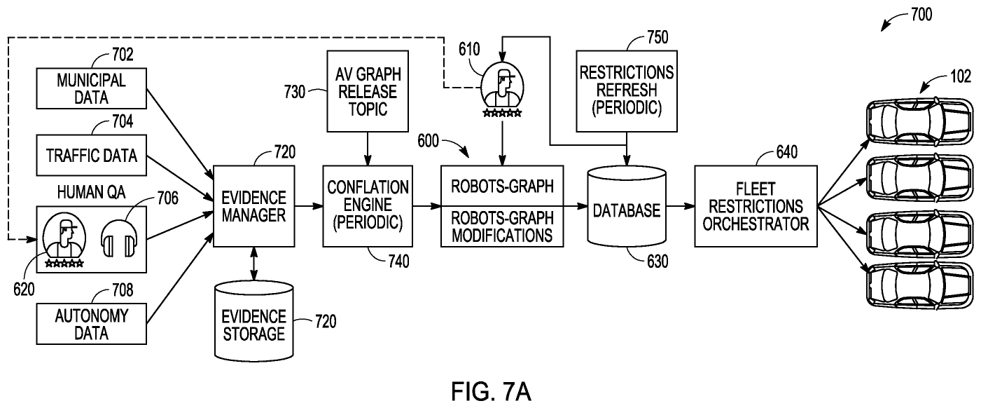

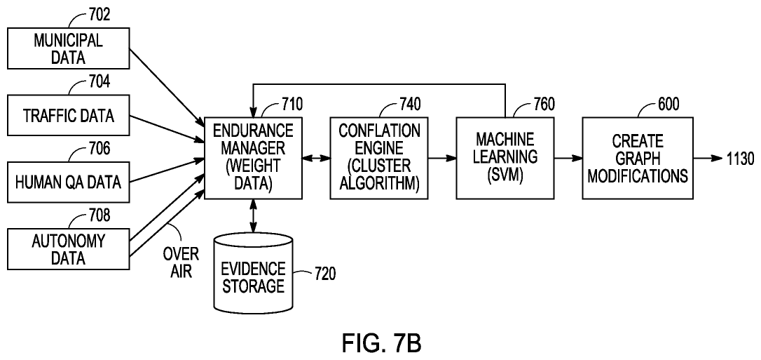

FIG. 7 depicts an automated NCS 700 according to example embodiments of the present disclosure. The NCS of the type depicted in FIG. 6 is modified to accept a variety of types of constraints data from known data sources that are processed and validated for inclusion as additional routing graph modifications as well as for use in setting time limits for the timely removal of expired routing graph modifications, thereby improving the coverage and accuracy of the routing graph modification models. In sample embodiments, the constraints data may be received from data source servers that provide, for example, municipal data (e.g., data extracted from construction permits) and Department of Transportation data 702 identifying, for example, when proposed road construction projects are expected to occur, vehicle routing/dispatch data and traffic data 704 from the vehicle fleet indicating that there is a reason to avoid certain roadway segments by identifying routes taken (and not taken) by the fleet vehicles being managed by the fleet restrictions orchestrator 640, the conventional human-generated routing graph and routing graph modification data 706 from the human QA 620, and autonomy data 708 including, for example, perception data captured by the fleet vehicles 102 identifying construction elements, and the like.

In sample embodiments, the municipal constraints data 702 may be received in a data stream from a plurality of municipalities where each data source is processed to identify the start and end data of different construction projects and the like that may lead to lane closures. For example, the Department of Transportation for the municipality may provide a spreadsheet or other shareable data format identifying construction projects by date and location and other specified attributes. It is noted that each entry in the spreadsheet is not necessarily in a routing graph configuration that would identify specific roadway elements affects by any construction. However, such information can be extracted from the location data using techniques described below.

In sample embodiments, the vehicle routing/dispatch data and traffic data 704 from the vehicle fleet may include traffic data from the fleet drivers that may be processed to identify construction cones, construction barriers, and the like that may be blocking roadway elements. Such data may include feedback from fleet drivers indicating that certain roadway elements are blocked or temporarily impassible due to an accident. For example, a driver may report a construction element in association with a routing graph feature. In addition, the vehicle routing/dispatch data may be processed to identify deviations from assigned routes and rerouting by vehicle drivers or autonomous vehicles using a system of the type described in U.S. Patent Application Serial No. (UP-00892US) entitled “Determining Dissimilarities Between Digital Maps and a Road Network Using Predicted Route Data and Real Trace Data,” the contents of which are incorporated herein by reference. For example, deviations by drivers from expected waypoints in assigned routes may be an indication that a roadway segment is blocked. The vehicle routing and traffic data 704 can be processed to identify departures from the proposed route that may be indicative of reasons to avoid certain roadway segments. When such deviations are identified as potential blockages, the associated data can be presented as evidence of a blockage of the identified roadway elements.

In sample embodiments, the autonomy data 708 may include perception data received from fleet vehicles over the air in real-time or collected by the autonomous vehicles 102 in the fleet and offloaded in batches at periodic intervals, such as once per day. The perception data can include classified elements in that can be loaded into a database in a queriable data format and provided as a data pipeline that is tagged as, for example, a blockage. The classified elements can be snipped from the perception data, time-stamped, and stored with the associated geometry data and/or picture of the element in context.

The data from the different data sources can have different data types and formats. The evidence manager 710 can process the data from the different data sources into standard formats for subsequent processing. For example, Lidar maps with tagged objects associated with roadway elements and/or vehicles in the perception data may be time-stamped and uploaded to the evidence storage 720. The location data can be standardized to refer to the same GPS coordinate system in the same manner, time routing graph modifications can be standardized into a common format, and the like. The received data also can be tagged with a universal identification tag for storage and recall. The associated time-stamped camera images in the perception data also can be uploaded by the evidence manager 710, processed into a standard display format, and stored in the evidence storage 720 as context information for those images that could be associated with a routing graph modification.

Once enough evidence has been acquired, the routing graph modification data can be provided to a conflation engine 740 for approximately associating the stored data to roadway elements by routing graph matching in two dimensions and identifying whether the data is indicative of a possible routing graph modification. In sample embodiments, the conflation engine 740 takes the raw evidence received from the evidence storage 720, associates it approximately with roadway elements, and makes a best guess of a routing graph modification. The proposed routing graph modification and supporting evidence is provided in a specific routing graph format. For example, at designated times (e.g., once per day) or upon receipt of a designated trigger event from AV routing graph release topic 730 indicating that the constraints data may be updated, or upon indication that an amount of data has been received, the standardized data is retrieved from the evidence storage 720 by the evidence manager 710 and provided to the conflation engine 740 for processing. Each new data source with evidence relating to the same roadway element is time stamped, processed, and associated with prior evidence based on location using clustering techniques, as described in more detail below. Any routing graph modifications generated by the conflation engine 740 are provided to the NCS 600 for use in updating the constraints data in the conventional fashion. On the other hand, instead of waiting for a designated trigger event, the routing graph modifications also can be periodically refreshed in response to a refresh signal from restrictions refresh unit 750 by reading in any new data from the data sources for processing.

In sample configurations, the conflation engine 740 picks roadway elements to review based on the evidence of routing graph modification data applicable to the respective roadway elements. The raw evidence is conflated to create routing graph modifications associated with the selected roadway elements. The conflation engine 740 can also establish whether a routing graph modification found by one data source is actually there or not by cross-referencing to the data from the other data sources. For example, the municipal data may indicate that a construction project is to conclude in a week, while the perception data indicates that the construction project has been completed.

It will be appreciated that the routing graph modification data received from the different data sources 702-708 may be noisy and potentially inconsistent. In other words, the received source data may include duplicates, incorrect data, conflicting data, and the like. To address such issues, the conflation engine 740 may implement a clustering algorithm such as k-means or a density-based spatial clustering of applications with noise (DBSCAN) to process the data received from the respective data sources 702-708 to identify a routing graph modification by a bounding box, latitude/longitude, down to an actual roadway element. The conflation engine 740 thus associates the possible routing graph modifications with roadway elements that are coordinated with the routing graph data, thus enabling the NCS 600 to focus on features that multiple sources have identified as possible routing graph modifications for review.

In sample embodiments, a DBSCAN algorithm can be used to match the received evidence to a routing graph and to identify potential clusters. DBSCAN is a density-based clustering non-parametric algorithm where given a set of points in some space, points are grouped together that are closely packed together (points with many nearby neighbors), marking as outliers points that lie alone in low-density regions (whose nearest neighbors are too far away). In sample embodiments, DBSCAN is used to construct a convex hull around each cluster to group data points to create a routing graph modification shape that may, in turn, be mapped to the routing graph.

In sample embodiments, DBSCAN can be implemented as follows:
1. Consider a set of points in some space to be clustered. In this case, the routing graph modification data from the respective data sources 702-708 may be selected as the set of points.
2. Let ε be a parameter specifying the radius of a neighborhood with respect to some point. For the purpose of DBSCAN clustering, the points are classified as core points, (density-)reachable points, and outliers, as follows:
   a. A point p is a core point if at least a minimum number of points (minPts) are within distance ε of it (including p).
   b. A point q is directly reachable from p if point q is within distance ε from core point p. Points are only said to be directly reachable from core points.
   c. A point q is reachable from p if there is a path p₁, . . . , pₙ with p₁=p and pₙ=q, where each pᵢ₊₁ is directly reachable from p₁. This implies that the initial point and all points on the path must be core points, with the possible exception of q.
   d. All points not reachable from any other point are outliers or noise points.
3. If p is a core point, then it forms a cluster together with all points (core or non-core) that are reachable from it. Each cluster contains at least one core point; non-core points can be part of a cluster, but they form its “edge” since they cannot be used to reach more points.

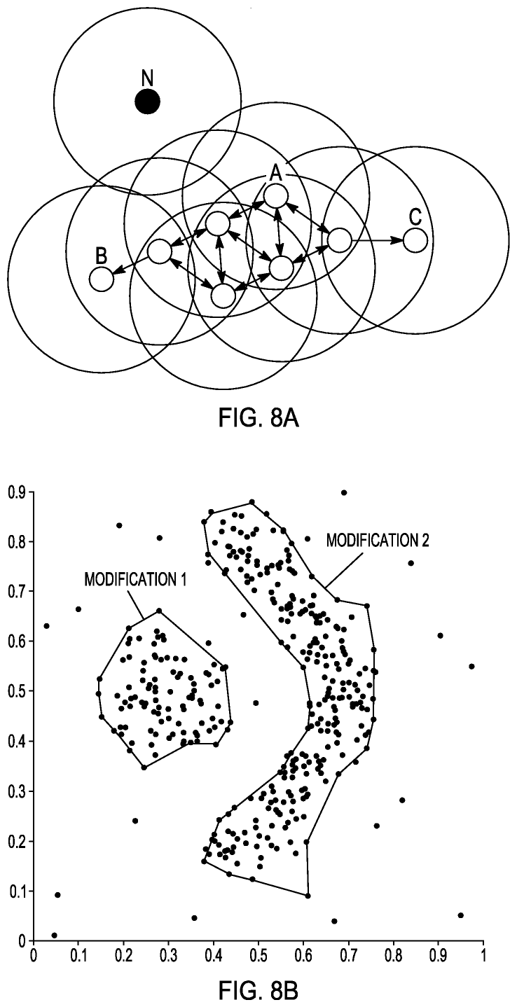

FIG. 8(a) illustrates an example of a DBSCAN where minPts=4. In this example, point A and the other dark points are core points from a first data source. In the illustrated example, the area surrounding these points in an ε radius contains at least 4 points (including the point itself). Because they are all reachable from one another, they form a single cluster. Points B and C may be from another data source. In this example, points B and C are not core points, but are reachable from A (via other core points) and thus belong to the cluster as well. For example, points B and C may have high precision but low corroboration. On the other hand, point N may be a noise point from another data source that is neither a core point nor directly-reachable and is thus likely referring to a different feature than points A, B and C. It is noted that reachability is not a symmetric relation. By definition, only core points can reach non-core points. The opposite is not true, so a non-core point may be reachable, but nothing can be reached from it. Therefore, a further notion of connectedness is used to formally define the extent of the clusters found by DBSCAN. Two points p and q are density-connected if there is a point o such that both p and q are reachable from o. Density-connectedness is symmetric. The resulting cluster satisfies two properties: All points within the cluster are mutually density-connected and if a point is density-reachable from some point of the cluster, it is part of the cluster as well. The data from the different data sources is thus bundled into a proposed routing graph modification and turned into a single routing graph modification by DBSCAN.

DBSCAN utilizes two parameters: c and the minimum number of points required to form a dense region (minPts). DBSCAN starts with an arbitrary starting point that has not been visited. This point's ε-neighborhood is retrieved, and if it contains sufficiently many points, a cluster is started. Otherwise, the point is labeled as noise. Note that this point might later be found in a sufficiently sized ε-environment of a different point and hence be made part of a cluster. If a point is found to be a dense part of a cluster, its ε-neighborhood is also part of that cluster. Hence, all points that are found within the ε-neighborhood are added, as is their own ε-neighborhood when they are also dense. This process continues until the density-connected cluster such as the density-connected cluster illustrated in FIG. 8(b) is completely found. Then, a new unvisited point is retrieved and processed, leading to the discovery of a further cluster or noise. DBSCAN may be used with any distance function (as well as similarity functions or other predicates), and the distance function may be viewed as an additional parameter.

In summary, a DBSCAN algorithm can be implemented by the conflation engine 740 to conflate the data from the data sources 702-708 by performing the following steps:
a. Find the points in the ε (eps) neighborhood of every point from the data sources, and identify the core points with more than minPts neighbors.
b. Find the connected components of core points on the neighbor graph, ignoring all non-core points.
c. Assign each non-core point to a nearby cluster if the cluster is an ε (eps) neighbor, otherwise assign it to noise.
   These steps may be performed for one point at a time to save memory. Once obtained, the resulting cluster(s) identified as Routing graph modification 1 and Routing graph modification 2 (e.g., FIG. 8(b)) may represent geographical clustering of the data from the data sources. Overlapping data from the data sources would have increased density and thus represent a proposed routing graph modification that may be presented to a human validator along with contextual information for validation prior to being applied to the routing graph data in sample embodiments. Similarly, the DBSCAN algorithm can identify when routing graph modifications can be safely removed based on the decreased data density from the data sources for the constrained roadway elements. In other sample embodiments, hierarchical clustering may be used to adjust granularity of the clusters (e.g., from a roadway element to a set of roadway elements to a city block) as the geographic area of the clusters is zoomed in and out.

Another problem may be that there is not enough information available for human validation. Generally, human validation is desired for safety reasons due to possible ambiguity and possible failure of the automatically generated routing graph modifications. To provide appropriate human validation, the human quality assurance validator 610 needs relevant context for the proposed routing graph modifications to make quality assurance decisions. To address this issue, the data from which the routing graph modification data has been automatically generated is arranged for presentation on a display to the human quality assurance validator for review to establish context for the proposed routing graph modification. For example, municipal data indicating a construction project may be paired with perception data showing traffic cones on the identified roadway segment. The human quality assurance validator 610 determines whether the proposed routing graph modification is an actual routing graph modification or not and removes false positives and false negatives as appropriate. The human quality assurance validator 610 may also remove a routing graph modification as appropriate. For example, expired routing graph modifications may be removed based on the timestamp of the routing graph modification and the evidence (or lack of evidence) of a routing graph modification for the indicated roadway elements. In other words, the human quality assurance validator 610 may choose to remove a routing graph modification if the routing graph modification may be safely removed as supported by the evidence of the status of the roadway element.

For example, the routing graph modification evidence from the data sources 702-708 that has been used to automatically generate the routing graph modification data is presented to the human QA 610 on a display for extraction of the context information. For example, in the case of municipal data, the name, license type, description, and the like may be displayed. On the other hand, in the case of autonomy data, a log GUID, a timestamp for the time of capture, a catalog video, and the like may be presented to the human QA 610. In some examples, the evidence contexts from multiple data sources 702-708 may be combined into one routing graph modification context with the associated routing graph modification context evidence presented to the human QA 610 for validation prior to acceptance and insertion into the routing graph modification database 630.

In sample embodiments, the human QA 610 not only provides a safety function by reviewing the routing graph modifications before they are added or removed from the routing graph modification database, but also the human QA 610 may provide supervised learning by feeding data back to reweight the inputs from the data sources. In other sample embodiments, the cluster classification and/or supervised learning performed by the human QA 610 may be replaced by a machine learning model. For example, as illustrated in FIG. 7(b), a machine learning model 760 may be provided in place of, or in addition (i.e., orthogonally) to, the clustering algorithm implemented by the conflation engine 740. For example, the machine learning model may comprise a support vector machine (SVM) that analyzes the conflated data from the conflation engine 740 for classification of proposed routing graph modifications in the received data. In sample embodiments, the support vector machine may implement support learning models with associated learning algorithms that mark training samples as belonging to one or the other of two categories to build a model that assigns new samples to one category or the other to provide a non-probabilistic binary linear classification model. New samples can be mapped to the same space created by the training samples and predicted to belong to a category based on where the new samples fall in the sample space. For example, a machine learning model may be used to classify whether data associated with a roadway segment is a routing graph modification or not.

As illustrated in FIG. 7(b), the machine learning model 760 can be placed after the conflation engine 740 to process the conflated data to determine whether the data may or may not be classified as a routing graph modification for presentation to the NCS 600 to create a routing graph modification to the routing graph. In sample embodiments, the conflation engine 740 is configured to provide data to the machine learning model in an expected format, and the machine learning model (e.g., support vector machine) can then determine the importance of the respective data points in the clusters. The machine learning model may also provide supervised learning by providing weighting feedback to the evidence manager 710 to apply weights to the respective inputs from the data sources 702-708. The appropriate weights may be applied as identified routing graph modifications (e.g., construction elements in perception data) are provided to the machine learning model for training purposes. It will be further appreciated that other machine learning elements (e.g., neural networks) may be used in place of the support vector machine, as would be apparent to those skilled in the art.

In sample embodiments, the expiration of a routing graph modification may be timing based or event based. If timing based, the routing graph modification automatically expires when the received routing graph modification data includes an expiration time for the routing graph modification. For example, in a sample configuration, a timing trigger may be received from the Department of Transportation indicating that a construction project has ended. On the other hand, if event based, a new computation can be triggered upon receipt of new conflicting evidence. If the computation with the new evidence indicates that a routing graph modification has been removed, the routing graph modification data may be removed from the routing graph modification database 630.

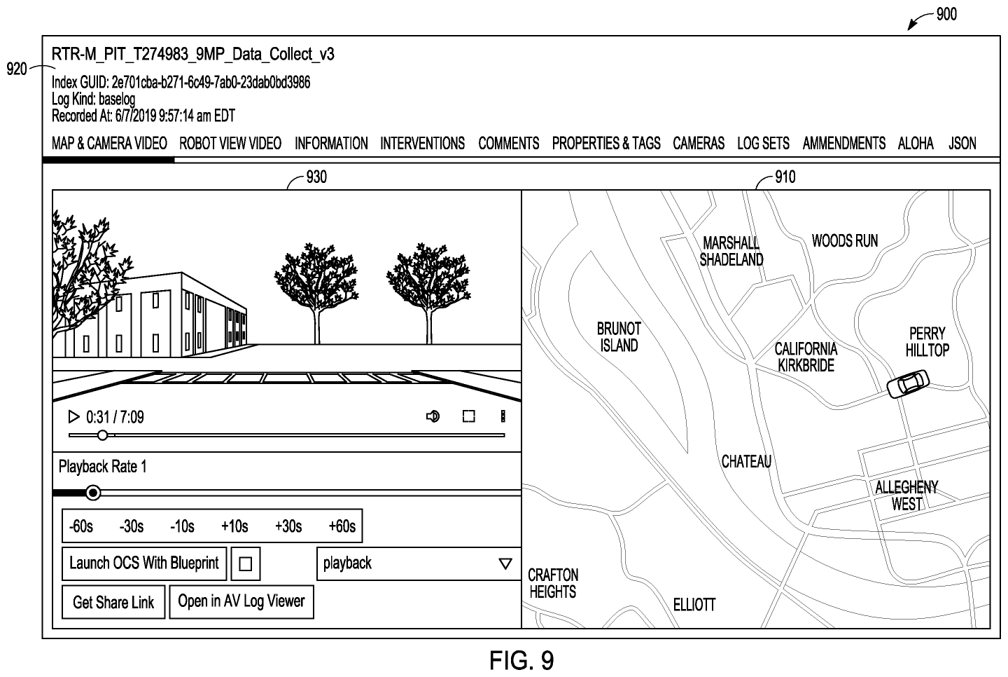

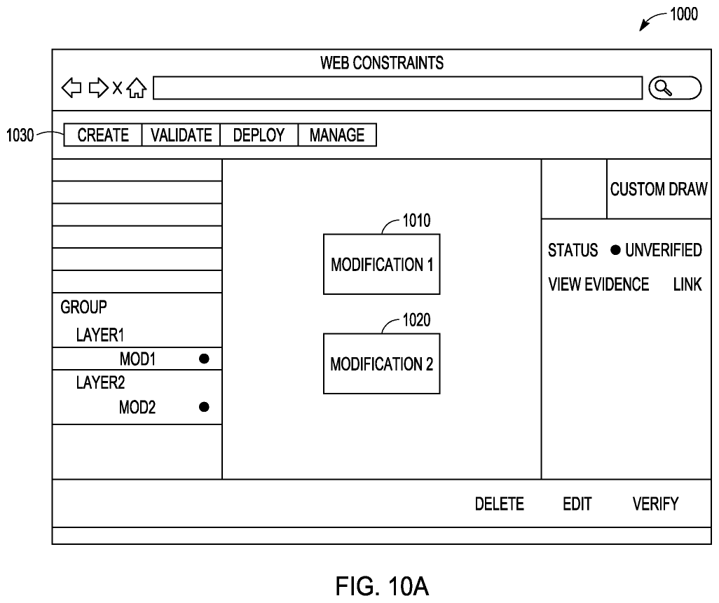

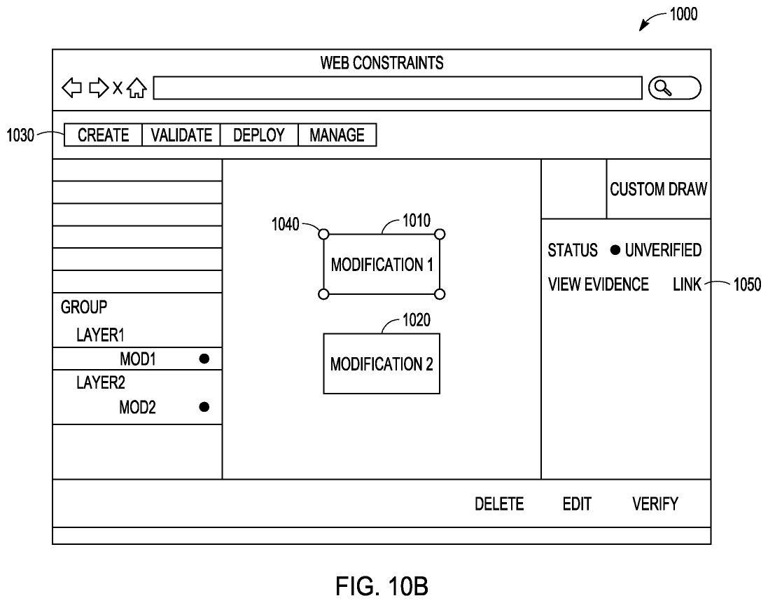

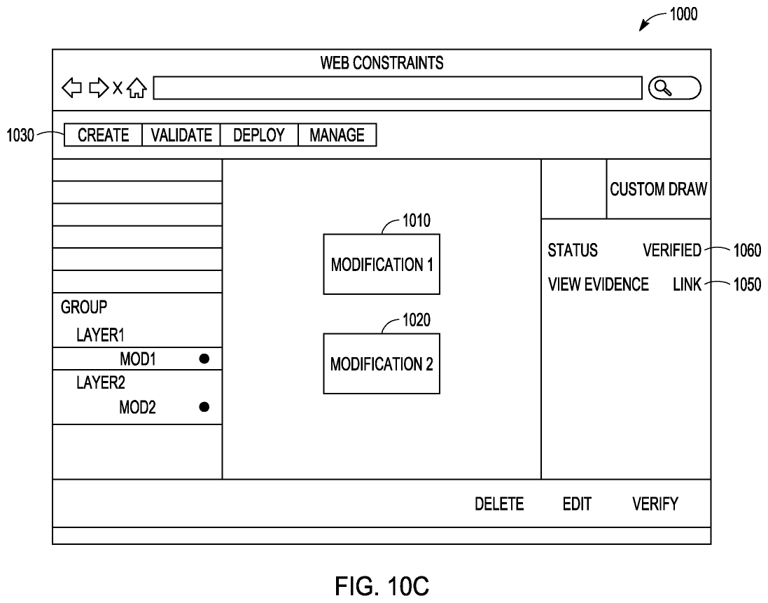

The typical human quality assurance flow for evaluation of the routing graph modification data can be modified as follows. The human QA 610 receives a list of routing graph modifications per geographic area (e.g., city) and a routing graph version for the geographic area. The human QA 610 also receives a routing graph visualization 910 and a routing graph modification metadata panel 920 and perception data display area 930 for displaying the routing graph and routing graph modification data as illustrated, for example, in the NCS display 900 in FIG. 9. As shown in FIG. 10(a), one or more routing graph modifications (e.g., Routing graph modifications 1 and 2 from FIG. 8(b)) can be proposed based on the automated processing of the received source data. In sample embodiments, the cluster data can be validated by the human QA 610 and/or classified by machine learning model 760 that has been trained to recognize patterns in the received data that are consistent with known routing graph modifications, such as a construction site. The proposed routing graph modifications 1010 and 1020 for validation can be arranged for quick validation by a human and presented to the human QA 610 via application programming interface (API) 1000 for selection. The human QA 610 may elect to create a routing graph modification by selection of the “create” radio button 1030 and, upon receipt of an automatically generated routing graph modification 1010 and/or 1020, the supporting context data from evidence storage 720 can be presented to the human QA 610 for review. The proposed routing graph modification can be accepted without modification, can be modified, or can be rejected by the human QA 610. For example, as illustrated in FIG. 10(b), Routing graph modification 1 (1010) may be selected for editing, as indicated by the highlighting 1040 of Routing graph modification 1 (1010). During the validation, a view evidence link 1050 may be provided so that the human QA 610 may determine whether the proposed routing graph modification is appropriate or is not a routing graph modification (and thus misclassified).

Once the routing graph modification has been accepted by the human QA 610, the status of the routing graph modification can be changed from “unverified” to “verified” and/or by changing color as indicated at 1060 in FIG. 10(c), and the routing graph modification data is stored in the routing graph modification database 630 with time-stamped supporting information (if desired) for implementation by the fleet restrictions orchestrator 640. The human QA 610 may also determine whether to close particular roadway elements or to increase the costs of using the roadway elements for situations where the roadway element may be passable. In the latter case, the routing graph modification data can convey that the roadway element is suitable for manual driving only, a high cost avoid, unpassable, and the like. In sample embodiments, a default routing graph modification is a most restrictive routing graph modification that may be adjusted by the human QA 610 as appropriate to get the routing graph modifications in agreement. Alternatively, intelligence may be used to process the routing graph modifications into agreement instead of selecting the most restrictive. It will also be appreciated that multiple routing graph modification data processing pipelines may be run in parallel for each type of routing graph modification (e.g., high cost avoid, manual driving, unpassable, etc.) and aggregated for presentation to the human and/or machine learning arbiter of the routing graph modification data for rapid determinations of whether to add or remove routing graph modification data of the designated type.

It will be further appreciated that although a human may be onboard the autonomous vehicle 102, as in the case of vehicle assist with a human safety driver in the driver's seat, it is generally undesirable for safety purposes for the human to be an onboard arbiter of the routing graph modification data. Instead, the routing graph modification data can be processed and used to update the routing graph modifications as described above. However, it will be appreciated that the context data may also be provided to a human driver to inform the driver when driving near an identified roadway element that something has been tagged as a routing graph modification. The driver could be given the geometry, time stamp, and a link to camera imaging of the routing graph modification as captured in the routing graph modification database 630.

In other sample embodiments, the routing graph modifications may be evaluated in real-time or near real-time by adding time labels to the data and processing the timing data as an artifact. In this fashion, the time that a roadway segment or roadway element is not usable may be automated to indicate that a vehicle is not to use the roadway segment or roadway element at particular times. For example, the road construction may only occur from 9 am-5 pm each day. An event could be sent to close the affected roadway segments at 9 am and to open the affected roadway segments at 5 pm. Conversely, a single event can be used to indicate the time window that the roadway segment is to be closed.

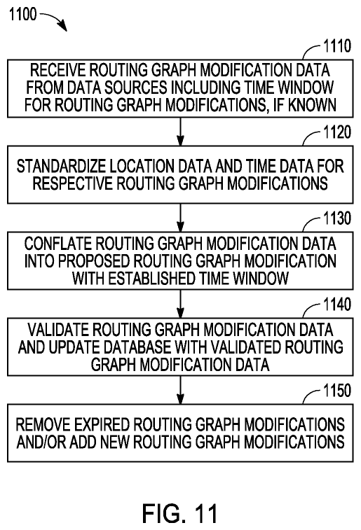

FIG. 11 depicts an example flow chart of an example method 1100 for automatically generating proposed routing graph modifications according to example embodiments of the present disclosure. One or more portion(s) of the method can be implemented by one or more computing devices such as, for example, the computing system 150 of FIG. 3. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

The method 1100 can include receiving routing graph modification data at 1110 from data sources 702-708 as described above with respect to FIG. 7. The routing graph modification data may include geographic location data (e.g., GPS data) identifying the location to which a routing graph modification may apply as well as timing data indicating the expected expiration of the routing graph modification (e.g., the expected end date of a construction project), if known. The received location data and timing data is processed at 1120 by the evidence manager 710 to standardize the representation of the location data and the timing data. Also, supporting metadata and video data is processed and provided to evidence storage to provide context for the proposed routing graph modifications. The routing graph modification data from the disparate data sources is further processed by the conflation engine 740 at 1130 to conflate the routing graph modification data into proposed routing graph modification data associated with particular roadway segments within an established time window (as available). The resulting routing graph modification data is provided to a human validator at 1140 to validate the routing graph modification data and, as appropriate, to update the routing graph modification database 630 with the validated routing graph modification data. Conversely, a machine learning model 760 may be used to validate (i.e., classify) the routing graph modification data. Also, the timing data associated with the routing graph modifications may trigger a refresh of the routing graph modification data when the associated routing graph modification is set to expire. Any expired routing graph modifications can then be added or removed at 1150. The routing graph modification data then can be applied to the fleet operator's routing graph by the fleet restrictions orchestrator 640 in a conventional fashion to manage the fleet operation.

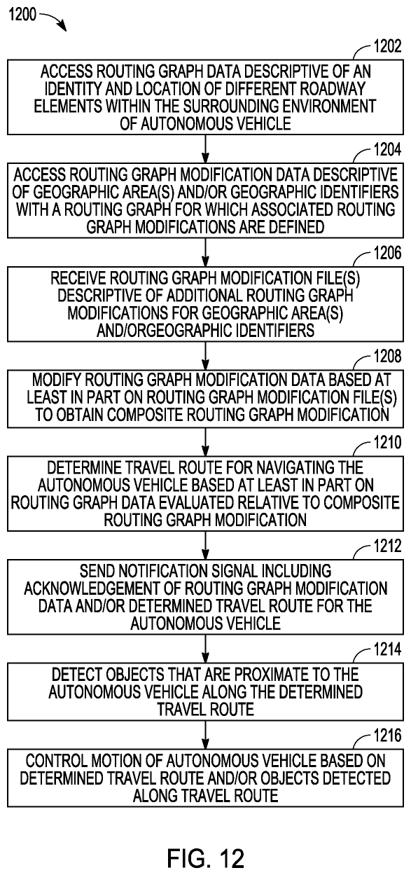

FIG. 12 depicts an example flow chart of a first example method 1200 of controlling navigation of an autonomous vehicle 102 according to example embodiments of the present disclosure. One or more portion(s) of the method 1200 can be implemented by one or more computing devices such as, for example, the computing device(s) 106 of FIG. 1. Moreover, one or more portion(s) of the method 1200 can be implemented as an algorithm on the hardware components of the device(s) described herein (e.g., as in FIGS. 1 and 2) to, for example, control the motion of an autonomous vehicle 102. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

The method 1200 can include accessing, retrieving, or otherwise obtaining routing graph data descriptive of an identity and location of different roadway elements within the surrounding environment of the autonomous vehicle at 1202. The routing graph data accessed at 1202 can include at least a portion of routing graph data 118 described in FIGS. 1-2. The routing graph data accessed at 1202 can provide information regarding the identity and location of different roadway elements (e.g., roads, roadway segments, roadway elements, parking lanes, turning lanes, bicycle lanes, or other portions of a particular roadway element). In some examples, roadway elements within routing graph data accessed at 1202 can include one or more descriptors including, for example, a district identifier for a routing graph coverage area containing the roadway element, a roadway element identifier, a start point for the roadway element, an end point for the roadway element, a directionality (e.g., direction of traffic flow), and/or connectivity identifiers for other roadway elements that are predecessors and/or successors to a given roadway element. Routing graph data accessed at 1202 also can include the identity and location of different items than roadway elements, including but not limited to buildings, maintenance/service locations for the autonomous vehicles, parking areas, traffic signs, traffic lights, traffic control devices, and/or any other routing graph data that provides information that assists the computing system in comprehending and perceiving its surrounding environment and its relationship thereto.

Method 1200 also can include accessing, retrieving, or otherwise obtaining routing graph modification data descriptive of one or more geographic areas and/or geographic identifiers within a routing graph at 1204 (e.g., routing graph data accessed at 1202) for which associated routing graph modifications are defined. The routing graph modification data accessed at 1204 can include at least a portion of routing graph modification data 120 described in FIGS. 1-2. Routing graph modification data accessed at 1204 can include different forms of information describing routing graph modifications. For example, routing graph modification data can include a priori routing graph modifications identifying particular roadway elements from which an autonomous vehicle 102 should be excluded or have a reduced likelihood of operation. For instance, routing graph modification data accessed at 1204 can prevent or reduce the likelihood of an autonomous vehicle 102 making a left hand turn in particular turn lanes of a given roadway element or roadway element when a vehicle is operating in a particular mode (e.g., fully autonomous mode).

In some implementations, routing graph modification data accessed at 1204 can include one or more portions of base routing graph modification data applied to a particular autonomous vehicle. In some implementations, the portions of base routing graph modification data selected for application to a particular vehicle can depend at least in part on factors such as the operation location, operating mode, or other factors associated with each autonomous vehicle. Different operating modes can include, for example, a fully autonomous mode in which an autonomous vehicle 102 operates without a human driver present in the vehicle, an autonomous mode in which the autonomous vehicle operates with a human driver in the vehicle, or other modes. Different operating modes can additionally or alternatively include, for example, whether a vehicle is currently engaged (e.g., on-task) or not engaged (e.g., off-task) in performing a service. For instance, some vehicles may currently have passengers on board that are being driven from one location to another, while other vehicles may be engaged in controlled navigation but not currently engaged in a particular operational task.

The method 1200 can further include receiving one or more routing graph modification files descriptive of additional routing graph modifications for one or more geographic areas and/or geographic identifiers at 1206. In some implementations, the one or more routing graph modification files received at 1206 can be received from one or more remote computing devices that are remote from the autonomous vehicle and that are configured to control operation of a fleet of autonomous vehicles. The one or more routing graph modification files can be generated by the one or more remote computing devices, for example, in response to identification of an event at some geographic location that will impact navigation at such location (e.g., road construction, a street fair, sporting event, traffic accident, parade, etc.) at a present and/or future time.

Each routing graph modification file received at 1206 can include a routing graph modification set including zero or more geographic identifiers as well as a default state (e.g., permit, forbid) indicating whether to by default permit or forbid access to roadway elements described by the routing graph modification file. Each geographic identifier described by the routing graph modification file(s) received at 1206 can be provided in a variety of suitable formats. Geographic identifiers can include, for example, one or more roadway element identifiers indicative of at least a portion of one or more roadway elements within a particular roadway segment, or other identifiers. Application types associated with each geographic identifier provided within the routing graph modification file(s) received at 1206 can also be provided in a variety of suitable formats. For example, the application type associated with each geographic identifier can be selected from a predetermined group of first application types (e.g., inclusion, exclusion, etc.). In another example, the application type associated with each geographic identifier can be selected from a predetermined group of second application types (e.g., partial, complete, etc.). In another example, the application type can be selected as a value from within a range of possible application type values (e.g., a number selected from within a range of 0-10 with 0 being least permissible or preferred and 10 being most permissible or preferred). In another example, an application type can correspond to an associated cost factor for navigating in a particular geographic area.

Method 1200 can further include generating composite routing graph modification data at 1208. Generating composite routing graph modification data at 1208 can include modifying the routing graph modification data accessed at 1204 based at least in part on the one or more routing graph modification files received at 1206. Routing graph modification data included within the one or more routing graph modification files received at 1206 can either append or revise existing routing graph modification data. In some examples, existing routing graph modification data includes base routing graph modification data determined for a particular vehicle. In some examples, existing routing graph modification data includes base routing graph modification data as well as routing graph modification data received in one or more previously received routing graph modification files. In such instances, routing graph modification files received at 1206 can sometimes completely overwrite previously received routing graph modification files such that modifying routing graph modification data at 1208 includes removing previously received routing graph modification files and adding newly received routing graph modification files. In some examples, routing graph modification files received at 1206 are added to and/or combined with previously received routing graph modification files when modifying routing graph modification data at 1208.

In some implementations, the routing graph modification data accessed at 1204 can include one or more inviolate routing graph modifications. Inviolate routing graph modifications can include those routing graph modifications that should not be changed or overwritten due to a level of importance in their application during autonomous navigation. In such instances, modifying routing graph modification data at 1208 can include adding to or revising the routing graph modification data accessed at 1204 in a manner that does not conflict with inviolate routing graph modifications within the routing graph modification data. The modification of routing graph modification data at 1208 can be implemented such that composite routing graph modification data always includes any inviolate routing graph modifications. In other words, modification of routing graph modification data at 1208 should not remove any routing graph modifications from the routing graph modification data accessed at 1204 that are identified as inviolate routing graph modifications.

The method 1200 can further include determining a travel route for navigating the autonomous vehicle 102 at 1210. The travel route determined at 1210 can be determined at least in part from routing graph data accessed at 1202 evaluated relative to the composite routing graph modification data generated at 1208. For example, the routing graph data accessed at 1202 can be evaluated in association with the composite routing graph modification data generated at 1208 to determine which roadway elements are permitted and/or which roadway elements are forbidden from possible navigable roadway elements within a set of routing graph data. In some examples, a travel route can be determined at 1210 that does not include a forbidden roadway element.

In some examples, a travel route can be determined at 1210 that gives preference to roadway elements having an application type associated with a lower cost factor. When routing graph modification data includes application types associated with cost factors, one or more computing devices associated with an autonomous vehicle 102 can determine a travel route at 1210 that minimizes a total cost based at least in part on cost factors associated with application types included as part of routing graph modification data 120 as well as optional additional cost factors, cost functions or the like for other navigational objectives. Depending on the manner of application type, travel routes can be determined at 1210 that not only can exclude particular roadway segments from navigation but that additionally or alternatively can reduce traffic in particular roadway segments based at least in part on evaluation of the routing graph modification data.

A travel route determined at 1210 can include, for example, a sequence of multiple roadway elements along which an autonomous vehicle can navigate, for example, to accomplish a predetermined navigational objective. Each roadway element within a determined travel route can be defined by one or more of a roadway element identifier, a start point, an end point, directionality, and/or connectivity identifiers for predecessor and/or successor roadway elements.

In some examples, travel routes determined at 1210 can be determined in accordance with a navigational objective (e.g., traveling to a destination location to perform a service such as rideshare service, delivery service, courier service, etc.). In some examples, travel routes determined at 1210 can be determined to accomplish the navigational objective using roadway elements that are permitted and/or preferred as opposed to forbidden and/or not preferred based on routing graph data evaluated in association with routing graph modification data. In some implementations, for example, it may be desirable to forbid or not prefer specific roadway segments due to events such as a traffic accident, street fair, construction, a parade, or the like. In other implementations, for example, it may be desirable to permit or prefer specific roadway segments for navigation by particular autonomous vehicles that are assigned to perform services in a given area, thus affording efficient distribution of fleet resources.

The method 1200 can further include sending a notification signal at 1212. In some examples notification signals sent at 1212 can be sent from a vehicle computing device 106 as depicted in FIGS. 1 and 2. In some examples, notification signals sent at 1212 can be sent to one or more remote computing devices 150 as depicted in FIG. 2. In some examples, notification signals sent at 1212 can be sent over a network 180 as depicted in FIG. 2. In some implementations, a notification signal sent at 1212 can include one or more of an acknowledgment of receipt of the one or more routing graph modification files received at 1206 and/or a confirmation of modification of routing graph modification data at 1208. In some implementations, a notification signal sent at 1212 can additionally or alternatively include the travel route determined at 1210.

The method 1200 can include detecting one or more objects that are proximate to the autonomous vehicle 102 at 1214 as it navigates along the travel route determined at 1210. Detection of objects at 1214 can be implemented by analyzing sensor data obtained from one or more sensors (e.g., image capture devices, RADAR devices, LIDAR devices, etc.) 104 depicted in FIG. 1. The perception system 110 of FIG. 1 can detect object(s) including, for example, pedestrians, other vehicles, bicycles, barriers, boundaries, traffic control devices, etc. The sensor data can be indicative of locations associated with the object(s) within the surrounding environment of the autonomous vehicle at one or more time(s). Perception system 110 can further analyze the sensor data to detect certain objects as objects of interest from background or other objects.

The method 1200 can include controlling motion of the autonomous vehicle at 1216 based at least in part on the travel route determined at 1210 and/or the one or more objects detected along the travel route at 1214. Motion of an autonomous vehicle 102 can be controlled at 1216 by determining a motion plan relative to the travel route. The motion plan can be configured to generally follow the travel route while concurrently planning to navigate appropriately relative to any detected objects proximate to the autonomous vehicle (e.g., pedestrians, other vehicles, traffic control devices, etc.) that are detected by the vehicle's sensors.

In some implementations, controlling motion of a vehicle at 1216 can be done in accordance with an optimization algorithm that considers cost factors associated with the routing graph modification data (e.g., application types having associated cost factors) as well as other cost factors or functions (e.g., based on speed limits, traffic lights, etc.), if any, to determine optimized variables that make up a motion plan. By way of example, motion of a vehicle can be controlled in a manner that accomplishes a navigational objective using permitted roadway elements from a travel route determined at 1210 without increasing the potential risk to the vehicle 102 and/or violating any traffic laws (e.g., speed limits, lane boundaries, signage).

Controlling motion of a vehicle at 1216 can include providing data indicative of a motion plan to a vehicle controller to implement the motion plan for the autonomous vehicle 102. For instance, an autonomous vehicle 102 can include a vehicle controller 116 as depicted in FIG. 1 that is configured to translate the motion plan into instructions. By way of example, the vehicle controller 116 can translate a determined motion plan into instructions to adjust the steering of the autonomous vehicle 102 “X” degrees, apply 10% braking force, modulate a speed of the autonomous vehicle 102, etc. The vehicle controller 116 can send one or more control signals to components of the vehicle controls 108 (e.g., braking control component, steering control component, speed/throttle control component) to execute the instructions and implement the motion plan.

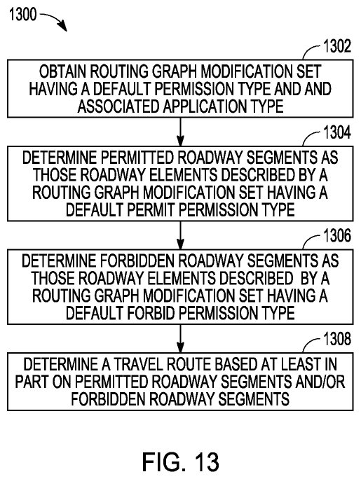

FIG. 13 depicts a flow chart of an example method 1300 of determining a travel route for an autonomous vehicle, such as referred to in 1210 of FIG. 12. One or more portion(s) of the method 1300 can be implemented by one or more computing devices such as, for example, the computing device(s) 106 of FIG. 1. Moreover, one or more portion(s) of the method 1300 can be implemented as an algorithm on the hardware components of the device(s) described herein (e.g., as in FIGS. 1 and 2) to, for example, control the motion of a vehicle. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

As illustrated at 1302, the method 1300 can include obtaining a routing graph modification set having a default state (e.g., permit or forbid) and being descriptive of zero or more geographic identifiers and associated application types (e.g., complete inclusion, complete exclusion. etc.).

The method 1300 can further include at 1304 determining permitted roadway elements. For instance, permitted roadway segments can be determined as those roadway elements that are described by a routing graph modification set having a default “permit” state.

The method 1300 can further include at 1306 determining forbidden roadway segments. For instance, forbidden roadway segments can be determined as those roadway elements that are described by a routing graph modification set having a default “forbid” state.

The method 1300 can further include at 1308 determining a travel route based at least in part on permitted roadway segments determined at 1304 and forbidden roadway segments determined at 1306. Determining a travel route at 1308 can be implemented, for example, by route determiner 122 of FIG. 1. Travel routes determined at 1308 can preferably consist of permitted roadway elements determined at 1304 without any of the forbidden roadway segments determined at 1306.

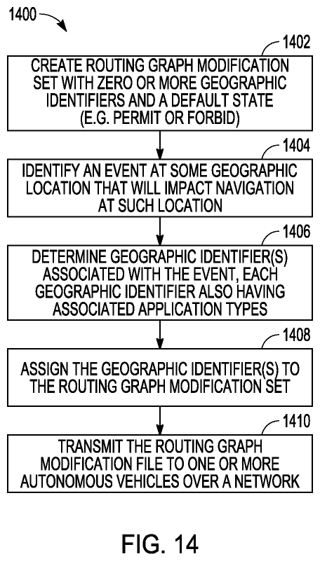

FIG. 14 depicts an example flow chart of a second example method 1400 of controlling navigation of an autonomous vehicle according to example embodiments of the present disclosure. One or more portion(s) of the method 1400 can be implemented by one or more computing devices such as, for example, the remote computing device(s) 150 of FIG. 2. In some examples, such remote computing device(s) can be included as part of a central control system that is in wireless communication with a plurality of autonomous vehicles, such as a fleet of autonomous vehicles providing one or more services (rideshare service, delivery service, courier service, etc.).

Moreover, one or more portion(s) of the method 1400 can be implemented as an algorithm on the hardware components of the device(s) described herein (e.g., as in FIG. 2) to, for example, control the motion of a vehicle. FIG. 14 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

As illustrated at 1402, the method 1400 can include creating a routing graph modification set with zero or more geographic identifiers and having a default state (e.g., permit or forbid). The default state can indicate whether to by default permit or forbid roadway segments described by a routing graph modification set and/or routing graph modification file that includes the routing graph modification set.

The method 1400 can further include at 1404 identifying an event at some geographic location that will impact navigation at such location (e.g., construction, a street fair, sporting event, traffic accident, parade, etc.). Identification of one or more events at 1404, for which the disclosed routing graph modification data can be determined, can come from data descriptive of an upcoming event (e.g., sporting event or the like) and/or historical data (e.g., by approximating navigational limitations based on past events in a particular geographic region at a certain time and/or date). Identification of one or more events at 1402 can be implemented using various databases to predict, approximate, and/or determine the events and/or geographic locations of anticipated navigational limitations. For example, for different geographic regions, event information (e.g., location, time, and/or date of the event, or the like) can be stored in an event database. Event information can be indicative of whether traffic can be higher or lower at a certain time period (e.g., a time period before the event begins versus a time period when the event is ongoing). In another example, event information can come from calendar databases that indicate important dates (e.g., holidays, first days of school for a city, voting day, or the like). Other examples of outside sources or other stored data (e.g., predicted future, current and/or historic events, conditions, or the like) include weather conditions, news information (e.g., fires, emergency situations, or the like), social information (e.g., via social networking websites), traffic conditions, flight information from airports and/or airlines, or the like, or other information that can assist in determining event information, traffic patterns, construction permits, or other data contributing to potential routing graph modifications.

For each event identified at 1404, routing graph modification data associated with the identified event can then be determined. For example, at 1406 the method 1400 can include determining one or more geographic identifiers associated with the event. Each geographic identifier determined at 1406 can also have an associated application type (e.g., inclusion, exclusion, complete, partial) for the geographic identifier. In some examples, determining one or more geographic identifiers at 1406 can be implemented using a drawing tool feature.

The method 1400 can further include assigning at 1408 the one or more geographic identifiers to the routing graph modification set created at 1402. A routing graph modification file including the routing graph modification set then can be transmitted at 1410 to one or more autonomous vehicles 102 over a network (e.g., network 180 of FIG. 2). In some examples, transmitting routing graph modification data at 1410 can be initiated using one or more graphical user interfaces.

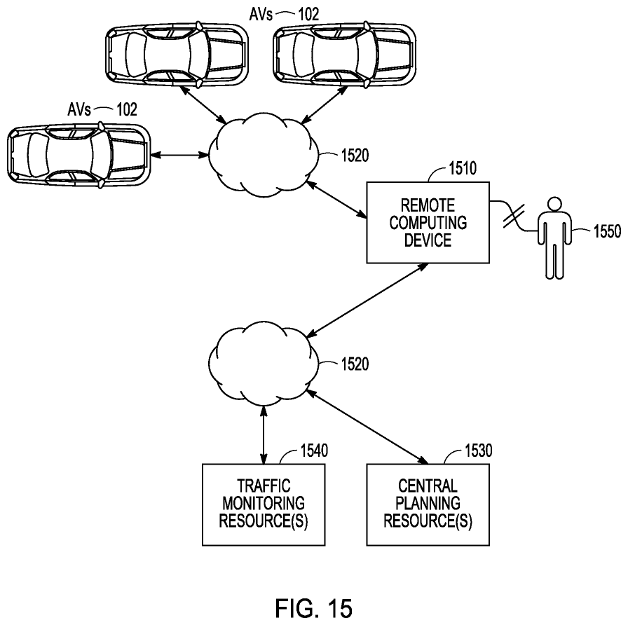

FIG. 15 depicts an example system for providing up-to-date route routing graph modification information to autonomous vehicles according to example embodiments of the present disclosure. In the below description of FIG. 15, the remote computing device 1510 can correspond to the remote computing device 150 as shown and described with respect to FIG. 2, and throughout the present disclosure. The remote computing device 1510 can communicate with a fleet of autonomous vehicles 102 operating throughout a given region (e.g., a metropolitan area or predefined operational grid on a road network) over one or more networks 1520. The remote computing device 1510 can further communicate with one or more central planning resources 1530 and/or one or more traffic monitoring resources 1540 over one or more networks 980.

As described herein, the traffic monitoring resources 1540 can monitor live traffic conditions for the given region and identify roadway segments that are currently jammed with traffic, blocked, or otherwise inaccessible. The traffic monitoring resources 1540 can be crowd-sourced or updated by users of a live traffic mapping resource or application or can comprise a central monitoring service that continually updates traffic conditions on a granular level (e.g., every roadway segment of the given region). In some aspects, the traffic monitoring resources 1540 can indicate the source for a live traffic routing graph modification, as well as the roadway element(s) affected. In doing so, the traffic monitoring resources 1540 can provide the remote computing device 1510 with contextual information for the live traffic routing graph modification. For example, the traffic monitoring resources 1540 can classify the live traffic routing graph modifications in terms of type (e.g., normal traffic jam, vehicle incident, spontaneous or unplanned event), estimated time of resolution (e.g., less than ten minutes, between ten and thirty minutes, or greater than thirty minutes), and/or size of the traffic routing graph modification (e.g., whether multiple parallel roadway segments are constrained).

The central planning resources 1530 may be updated by central planning authorities based on planned road and/or lane closures for the given region. For example, the central planning resources 1530 can indicate permitted events requiring closure of a certain roadway segment during a certain time frame. Such permitted events can comprise parades, festivals, protests, road construction, utility servicing, and other planned events involving a road or lane closure. As noted above with respect to FIG. 7, this information may be provided to the NCS as routing graph modification data 702 from municipal sources.

In accordance with examples described herein, the remote computing device 1510 update the autonomy routing graph modifications for the given region based on the planned lane or road closures indicated by the central planning resources 1530 and the live traffic routing graph modifications indicated by the traffic monitoring resources 1540. In certain examples, the remote computing device 1510 can be manually operated by an administrator 1550. For manual implementations, the administrator 1550 can manually access the traffic monitoring resources 1540 and/or central planning resources 1530 over one or more networks 1520 to determine any traffic or roadway segment routing graph modifications for the given region. The administrator 1550 may then manually update autonomy routing graph modifications that dictate roadway elements through which the autonomous vehicles 102 may operate.

In variations, the autonomy routing graph modifications may be automatically updated by the remote computing device 1510 using the techniques described herein. For example, the remote computing device 1510 can periodically or continuously parse through any live traffic routing graph modifications and planned road or lane closures indicated by the traffic monitoring resources 1540 and central planning resources 1530 to extract routing graph modification data that is used by the system of FIG. 7 to update the autonomy routing graph modifications for the autonomous vehicles 102. The remote computing device 1510 may then transmit traffic flow routing graph modification information identifying the closed roadway segments to the autonomous vehicles 102 over the network(s) 1520. For example, the remote computing device 1510 can generate a routing graph modification file comprising the traffic flow routing graph modification information indicating the excluded roadway segments, and transmit the routing graph modification file to the autonomous vehicles 102 over the network(s) 1520.

As described herein, the remote computing device 1510 can transmit the traffic flow routing graph modification information to all autonomous vehicles 102 or selectively. For example, the remote computing device 1510 can manage an on-demand transport service that routes the autonomous vehicles 102 throughout the given region based on user demands (e.g., for freight delivery, food delivery, passenger transport, etc.). In such examples, the remote computing device 1510 can selectively transmit the traffic flow routing graph modification information to only those autonomous vehicles 102 that are routed to converge towards or intersect with the excluded roadway elements.

Based on the traffic flow routing graph modification information transmitted from the remote computing device 1510, the autonomous vehicles 102 can perform route planning operations accordingly. For example, the remote computing device 1510 or other transportation coordination system can provide the autonomous vehicles 102 with a sequence of destinations for making pick-ups and drop-offs. The on-board of off-board computing systems of the autonomous vehicles 102 can generate respective route plans to autonomously drive to a next destination. Based on the routing graph modification file(s), comprising the traffic flow routing graph modification information, received from the remote computing device 1510, the autonomous vehicles 102 can inherently avoid the exclusion zones or forbidden roadway segments. Accordingly, the remote computing device 1510 can leverage the live-traffic routing graph modifications and planned closures indicated by the traffic monitoring resources 1540 and central planning resources 1530 to create exclusion zones within the given region in which the autonomous vehicles 102 operate. The remote computing device 1510 can then generate routing graph modification files identifying the exclusion zones and transmit the routing graph modification files to the autonomous vehicles.

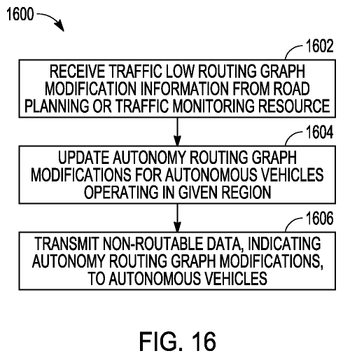

FIG. 16 depicts an example flow chart of a method 1600 of providing up-to-date route routing graph modification information to autonomous vehicles according to example embodiments of the present disclosure. One or more portion(s) of the method 1600 can be implemented by one or more computing devices such as, for example, the remote computing device(s) 150, 1510 of FIGS. 2 and 15. In some examples, such remote computing device(s) can be included as part of a central control system that is in wireless communication with a plurality of autonomous vehicles, such as a fleet of autonomous vehicles providing one or more services (rideshare service, delivery service, courier service, etc.). Furthermore, in the below description of FIG. 16, reference may be made to reference characters representing like features as shown and described with respect to FIG. 15.

FIG. 16 illustrates the remote computing device 1510 receiving or accessing traffic flow routing graph modification information from one or more central road planning resources 1530 and/or traffic monitoring resources 1540 at 1602. As described herein, the traffic flow routing graph modification information may be accessed and received manually by an administrator 1550 or automatically or semi-automatically by the remote computing device 1510 as described above with respect to FIG. 7. Based on the traffic routing graph modification information, the remote computing device 1510 can update autonomy routing graph modifications for autonomous vehicles 102 operating in the given region at 1604. As provided herein, the “autonomy routing graph” can comprise a road grid within a road network on which the autonomous vehicles 102 can operate. In certain implementations, the autonomy routing graph corresponds to on-board localization routing graphs that the autonomous vehicles 102 utilize to compare with live sensor data. Accordingly, in updating the autonomy routing graph modifications, the remote computing device 1510 can generate forbidden roadway segments through which the autonomous vehicles 102 are forbidden to operate.

The remote computing device 1510 may then generate and transmit non-routable data, indicating the autonomy routing graph modifications, to the autonomous vehicles 102 at 1606. In various examples described herein, the remote computing device 1510 generates a routing graph modification file that defines the non-routable data (e.g., identifying the roadway segments that are closed or blocked), and transmits the routing graph modification file to the autonomous vehicles 102. Thereafter, the autonomous vehicles 102 are prevented from planning routes that enter the forbidden roadway segments.

The routing graph modifications are implemented by the routing graph modification deployment module 350 (FIG. 3) by consolidating all routing graph modifications handling within the route determiner 122 and route planning graph generation. The routing graph modifications may be managed by identifying roadway elements that are forbidden roadway elements, force manual roadway elements, high cost roadway elements, etc. In sample embodiments, the route determiner 122 accepts (and makes a copy) of these roadway element sets as multiple separated items. Forbidden connections are received along with wide or narrow cost field routing graph modifications. For each roadway element, the routing graph modifications deployment module 350 returns the effect of all of these routing graph modifications. For each pair of roadway elements, the routing graph modifications deployment module 350 returns if it is forbidden. The routing graph modifications deployment module 350 also accepts subscribers for routing graph modification changes notification and calls the subscribers' callback functions whenever a routing graph modification is changed. The routing logic is not changed; the routing logic applies the weights or forbidden nature of a route when it calculates its route through roadway elements marked with a routing graph modification and based on the location of the vehicle relative to the roadway elements marked with the routing graph modification. A routing engine for implementing the routing logic may be included in the route determiner 122 on the vehicle or may be included in an offboard system located in a cloud routing engine, for example.

In sample embodiments, the routing engine in the route determiner 122 receives the active route routing graph modifications (e.g., FBR, HCA, and RNA) as described herein along with a list of roadway elements that are to be considered for optimal routing. The active routing graph modifications are received in a file, and the route determiner 122 accepts and makes a copy of the roadway element set as multiple separated items. The route determiner 122 also receives forbidden connections and wide or narrow cost field routing graph modifications. For each roadway element, the active routing graph modifications are processed to apply the appropriate routing graph modifications to the respective roadway elements. Similarly, for each pair of roadway elements, the active routing graph modifications are processed to determine if the roadway element pair is forbidden. The routing graph modification changes are provided in notifications to subscribers to the routing data to indicate that a routing graph modification has been changed.

It will be appreciated by those skilled in the art that an autonomous vehicle that is moving when the routing graph modifications are imposed may enter the roadway elements marked as constrained roadway elements before it has time to stop and/or reroute. In such cases, the area occupied by the autonomous vehicle may be expanded to include those roadway elements needed to stop and/or reroute the autonomous vehicle as it approaches roadway elements marked as constrained roadway elements.

It will also be appreciated by those skilled in the art that the routing graph modifications described herein need not be limited to routing for autonomous vehicles. On the contrary, the techniques described herein may also be used to identify routing graph modifications for roadway segments where human drivers in a fleet should not be routed due to construction and the like.

### Hardware Diagrams

The technology discussed herein makes reference to computing devices, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, computer-implemented processes discussed herein can be implemented using a single computing device or multiple computing devices working in combination. Databases and applications can be implemented on a single system or distributed across multiple systems. Distributed components can operate sequentially or in parallel. Furthermore, computing tasks discussed herein as being performed at computing device(s) remote from the vehicle can instead be performed at the vehicle (e.g., via the vehicle computing system), or vice versa. Such configurations can be implemented without deviating from the scope of the present disclosure.

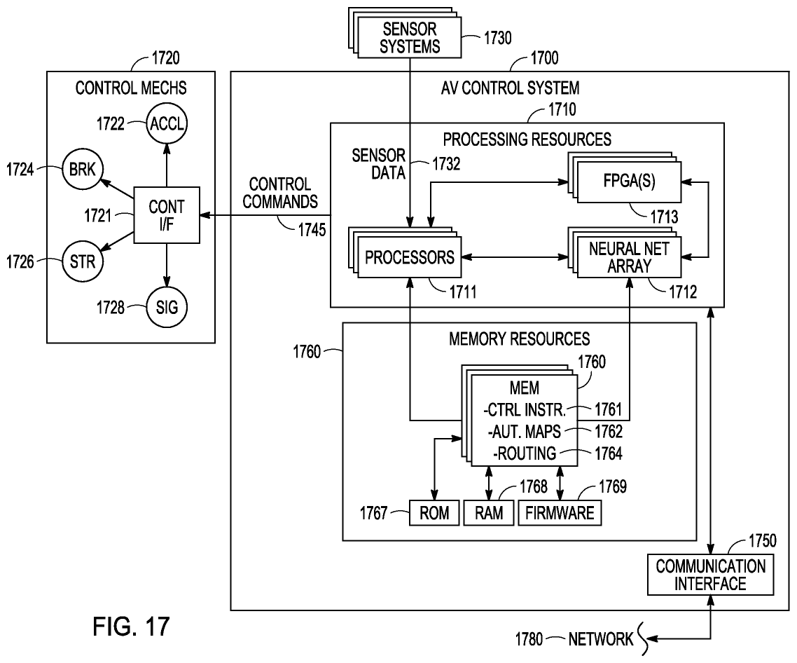

FIG. 17 is a block diagram illustrating a computer system upon which example AV processing systems described herein may be implemented. The computer system 1700 can be implemented using a number of processing resources 1710, which can comprise processors 1711 and field programmable gate arrays (FPGAs) 1713. In some aspects, any number of processors 1711 and/or FPGAs 1713 of the computer system 1700 can be utilized as components of a neural network array 1712 implementing one or more machine learning models and utilizing road network maps stored in memory 1761 of the computer system 1700. In the context of FIG. 1, various aspects and components of the AV computing device 106 can be implemented using one or more components of the computer system 1700 shown in FIG. 17.

According to some examples, the computer system 1700 may be implemented within an autonomous vehicle (AV) with software and hardware resources such as described with examples of FIG. 1. In an example shown, the computer system 1700 can be distributed spatially into various regions of the autonomous vehicle 102, with various aspects integrated with other components of the autonomous vehicle 102 itself. For example, the processing resources 1710 and/or memory resources 1760 can be provided in a cargo space of the autonomous vehicle 102. The various processing resources 1710 of the computer system 1700 can also execute control instructions 1762 using processors 1711, FPGAs 1713, a neural network array 1712, or any combination of the same. In addition, the computer system 1700 may be in communication with a passenger feedback system of the autonomous vehicle 102, which can include a feedback controller comprising a set of processing and local memory resources storing feedback instructions.

In an example of FIG. 17, the computer system 1700 includes a communication interface 1750 that can enable communications over a network 1780. In one implementation, the communication interface 1750 can also provide a data bus or other local links to electro-mechanical interfaces of the vehicle, such as wireless or wired links to and from control mechanisms 1720 (e.g., via a control interface 1721), sensor systems 1730, and can further provide a network link to a backend transport management system or a remote assistance system (implemented on one or more datacenters) over one or more networks 1780.

The memory resources 1760 can include, for example, main memory 1761, a read-only memory (ROM) 1767, a storage device, and cache resources. The main memory 1761 of memory resources 1760 can include random access memory (RAM) 1768 or other dynamic storage device for storing information and instructions that are executable by the processing resources 1710 of the computer system 1700. The processing resources 1710 can execute instructions for processing information stored with the main memory 1761 of the memory resources 1760. The main memory 1761 can also store temporary variables or other intermediate information which can be used during execution of instructions by the processing resources 1710. The memory resources 1760 can also include ROM 1767 or other static storage device for storing static information and instructions for the processing resources 1710. The memory resources 1760 can also include other forms of memory devices and components, such as a magnetic disk or optical disk, for purpose of storing information and instructions for use by the processing resources 1710. The computer system 1700 can further be implemented using any combination of volatile and/or non-volatile memory, such as flash memory, PROM, EPROM, EEPROM (e.g., storing firmware 1769), DRAM, cache resources, hard disk drives, and/or solid-state drives.

The memory 1761 may also store localization maps 1764 in which the processing resources 1710—executing the control instructions 1762—can continuously compare to sensor data from the various sensor systems 1730 of the autonomous vehicle 102. Execution of the control instructions 1762 can cause the processing resources 1710 to generate control commands 1715 in order to autonomously operate the AV's acceleration 1722, braking 1724, steering 1726, and signaling systems 1728 (collectively, the control mechanisms 1720). Thus, in executing the control instructions 1762, the processing resources 1710 can receive sensor data 1732 from the sensor systems 1730, dynamically compare the sensor data 1732 to a current localization map 1764 and generate control commands 1715 for operative control over the acceleration, steering, and braking of the autonomous vehicle 102. The processing resources 1710 may then transmit the control commands 1715 to one or more control interfaces 1721 of the control mechanisms 1720 to autonomously operate the autonomous vehicle 102 through road traffic on roads and highways, as described throughout the present disclosure.

The memory 1761 may also store routing information 1766 that the processing resources 1710 can utilize to determine routes for the autonomous vehicle 102 to any given destination. In certain examples described herein, the routing information 1766 can further be provided to a network computing system 100 (FIG. 1) to enable the network computing system 100 to select or filter out the autonomous vehicle 102 as a candidate to service transport requests.

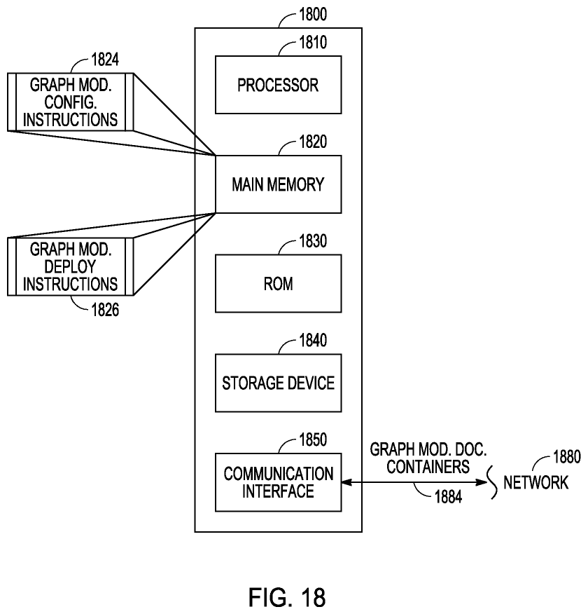

FIG. 18 is a block diagram that illustrates a computer system upon which examples described herein may be implemented. A computer system 1800 can be implemented on, for example, a server or combination of servers. For example, the computer system 1800 may be implemented as part of a network service for providing transportation services. In the context of FIGS. 1 and 2, the network computing system 100, 200 may be implemented using a computer system 1800 such as described by FIG. 18.

In one implementation, the computer system 1800 includes processing resources 1810, a main memory 1820, a read-only memory (ROM) 1830, a storage device 1840, and a communication interface 1850. The computer system 1800 includes at least one processor 1810 for processing information stored in the main memory 1820, such as provided by a random-access memory (RAM) or other dynamic storage device, for storing information and instructions which are executable by the processor 1810. The main memory 1820 also may be used for storing temporary variables or other intermediate information during execution of instructions to be executed by the processor 1810. The computer system 1800 may also include the ROM 1830 or other static storage device for storing static information and instructions for the processor 1810. A storage device 1840, such as a magnetic disk or optical disk, is provided for storing information and instructions.

The communication interface 1850 enables the computer system 1800 to communicate over one or more networks 1880 (e.g., cellular network) through use of the network link (wireless or wired). Using the network link, the computer system 1800 can communicate with one or more computing devices, one or more servers, and/or one or more autonomous vehicles 102. The executable instructions stored in the memory 1820 can include selection and routing graph modification configuration instructions 1824, which enables the computer system 1800 to provide a routing graph modification interface and receive inputs to amend autonomy routing graph documents from a fleet operator. The instructions can further include routing graph modification deployment instructions 1826 which enables the computer system 1800 to compress edited autonomy routing graph documents into document images or snapshots and compiled for transmission to autonomous vehicles 102 for integration into existing autonomy routing graphs.

The processor 1810 is configured with software and/or other logic to perform one or more processes, steps and other functions described with implementations, such as described with respect to FIGS. 1-17, and elsewhere in the present application. Examples described herein are related to the use of the computer system 1800 for implementing the techniques described herein. According to one example, those techniques are performed by the computer system 1800 in response to the processor 1810 executing one or more sequences of one or more instructions contained in the main memory 1820. Such instructions may be read into the main memory 1820 from another machine-readable medium, such as the storage device 1840. Execution of the sequences of instructions contained in the main memory 1820 causes the processor 1810 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature. Thus, the absence of describing combinations should not preclude claiming rights to such combinations.

The technology discussed herein makes reference to computing devices, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, computer implemented processes discussed herein can be implemented using a single computing device or multiple computing devices working in combination. Databases and applications can be implemented on a single system or distributed across multiple systems. Distributed components can operate sequentially or in parallel. Furthermore, computing tasks discussed herein as being performed at computing device(s) remote from the vehicle can instead be performed at the vehicle (e.g., via the vehicle computing system), or vice versa. Such configurations can be implemented without deviating from the scope of the present disclosure.

The various memories (i.e., 1820, 1830, and/or memory of the processor unit(s) 1810 and/or storage device 1840) may store one or more sets of instructions and data structures (e.g., instructions) 1824 and 1826 embodying or used by any one or more of the methodologies or functions described herein. These instructions, when executed by processor unit(s) 1810 cause various operations to implement the disclosed examples.

As used herein, the terms “machine-storage medium,” “device-storage medium,” “computer-storage medium” (referred to collectively as “machine-storage medium”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media specifically exclude carrier waves, modulated data signals, and other such media, at least some of which are covered under the term “signal medium” discussed below.

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 1824 and 1826 can further be transmitted or received over a communications network 1880 using a transmission medium via the network interface device 1850 using any one of a number of well-known transfer protocols (e.g., HTTP). Examples of communication networks include a LAN, a WAN, the Internet, mobile telephone networks, plain old telephone service (POTS) networks, and wireless data networks (e.g., Wi-Fi, 3G, 4G LTE/LTE-A, 5G or WiMAX networks). The term “transmission medium” shall be taken to include any intangible medium that is capable of storing, encoding, or carrying instructions for execution by the machine, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other examples can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as examples can feature a subset of such features. Further, examples can include fewer features than those disclosed in a particular example. Thus, the following claims are hereby incorporated into the Detailed Description, with each claim standing on its own as a separate example. The scope of the examples disclosed herein is to be determined with reference to the appended claims, along with the full scope of equivalents to which such claims are entitled.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method of creating routing graph modifications for a navigation constraints system that controls navigation of an autonomous vehicle, comprising:
receiving, by one or more processors, routing graph modification data from at least one data source, the routing graph modification data including geographic location data identifying a location to which a routing graph modification applies, the at least one data source including at least one of a municipal data source, a traffic data source, routing/dispatch data from a routing/dispatch system, or perception data collected by an autonomous vehicle;
associating, by the one or more processors, the routing graph modification data with one or more roadway elements in a routing graph of the navigation constraints system;
evaluating the routing graph modification data associated with the one or more roadway elements to classify the routing graph modification data as a routing graph modification associated with the one or more roadway elements; and
providing, by the one or more processors, the routing graph modification data of the routing graph modification to the navigation constraints system.

2. The method of claim 1, wherein the routing graph modification data from the at least one data source includes timing data indicating a duration of a routing graph modification, further comprising associating, by the one or more processors, a routing graph modification expiration time with the routing graph modification.

3. The method of claim 2, further comprising instructing, by the one or more processors, the navigation constraints system to remove an expired routing graph modification.

4. The method of claim 2, further comprising triggering, by the one or more processors, a refresh of routing graph modification data of the navigation constraints system when the routing graph modification expiration time has been reached.

5. The method of claim 1, further comprising standardizing, by the one or more processors, representations of the routing graph modification data from the at least one data source and storing standardized representations of the routing graph modification data in an evidence storage.

6. The method of claim 1, wherein the associating comprises providing, by the one or more processors, the routing graph modification data to a clustering algorithm that clusters the routing graph modification data by geographic location and routing graphs clustered routing graph modification data to the one or more roadway elements in the routing graph of the navigation constraints system.

7. The method of claim 6, further comprising associating, by the one or more processors, the clustered routing graph modification data mapped to the one or more roadway elements in the routing graph of the navigation constraints system with supporting context data including at least one of metadata or video.

8. The method of claim 7, wherein evaluating the routing graph modification data comprises providing, by the one or more processors, the clustered routing graph modification data mapped to the one or more roadway elements in the routing graph of the navigation constraints system and the supporting context data to a display interface and enabling a human to provide inputs via the display interface to classify the routing graph modification data as the routing graph modification associated with the one or more roadway elements.

9. The method of claim 6, wherein evaluating the routing graph modification data comprises providing, by the one or more processors, the clustered routing graph modification data mapped to the one or more roadway elements in the routing graph of the navigation constraints system to a machine learning classification model to classify the routing graph modification data as the routing graph modification associated with the one or more roadway elements.

10. The method of claim 9, further comprising weighting, by the one or more processors, the routing graph modification data received from respective data sources of the at least one data source by feeding back weighting data from the machine learning classification model to provide supervised learning.

11. A navigation constraints system that controls navigation of an autonomous vehicle, comprising:
a memory that stores instructions; and
one or more processors that execute the instructions from the memory to perform operations comprising:
receiving routing graph modification data from at least one data source, the routing graph modification data including geographic location data identifying a location to which a routing graph modification applies, the at least one data source including at least one of a municipal data source, a traffic data source, routing/dispatch data from a routing/dispatch system, or perception data collected by an autonomous vehicle;
associating the routing graph modification data with one or more roadway elements in a routing graph;
enabling evaluation of the routing graph modification data associated with the one or more roadway elements to classify the routing graph modification data as a routing graph modification associated with the one or more roadway elements;
determining a travel route for navigating the autonomous vehicle based at least in part on navigational routing graph data evaluated relative to the routing graph modification associated with the one or more roadway elements; and
controlling motion of the autonomous vehicle based at least in part on the determined travel route.

12. The system of claim 11, wherein the routing graph modification data from the at least one data source includes timing data indicating a duration of a routing graph modification, the one or more processors further executing the instructions to perform operations including associating a routing graph modification expiration time with the routing graph modification.

13. The system of claim 12, the one or more processors further executing the instructions to perform operations including removing an expired routing graph modification.

14. The system of claim 12, the one or more processors further executing the instructions to perform operations including triggering a refresh of routing graph modification data of the navigation constraints system when the routing graph modification expiration time has been reached.

15. The system of claim 11, further comprising an evidence storage, the one or more processors further executing the instructions to perform operations including standardizing representations of the routing graph modification data from the at least one data source and storing standardized representations of the routing graph modification data in the evidence storage.

16. The system of claim 11, the one or more processors further executing the instructions to execute a clustering algorithm to cluster the routing graph modification data by geographic location and to map clustered routing graph modification data to the one or more roadway elements in the routing graph.

17. The system of claim 16, the one or more processors further executing the instructions to associate the clustered routing graph modification data mapped to the one or more roadway elements in the routing graph with supporting context data including at least one of metadata or video.

18. The system of claim 17, further comprising a display interface, the one or more processors further executing the instructions to provide the clustered routing graph modification data mapped to the one or more roadway elements in the routing graph and the supporting context data to the display interface and to enable a human to provide inputs via the display interface to classify the routing graph modification data as the routing graph modification associated with the one or more roadway elements.

19. The system of claim 16, wherein the clustering algorithm comprises one of a k-means clustering algorithm or a density-based spatial clustering of applications with noise (DBSCAN) clustering algorithm.

20. A non-transitory computer-readable medium storing instructions that, when executed by one or more processors, cause the one or more processors to create routing graph modifications for a navigation constraints system that controls navigation of an autonomous vehicle, by:
receiving routing graph modification data from at least one data source, the routing graph modification data including geographic location data identifying a location to which a routing graph modification applies, the at least one data source including at least one of a municipal data source, a traffic data source, routing/dispatch data from a routing/dispatch system, or perception data collected by an autonomous vehicle;
associating the routing graph modification data with one or more roadway elements in a routing graph of the navigation constraints system;
enabling evaluation of the routing graph modification data associated with the one or more roadway elements to classify the routing graph modification data as a routing graph modification associated with the one or more roadway elements; and
providing the routing graph modification data of the routing graph modification to the navigation constraints system.
